(19) United States
(12) Patent Application Publication
(10) Pub. No.: US 2013/0344869 A1
(43) Pub. Date: Dec. 26, 2013

(54) COORDINATED MULTIPOINT RESOURCE MANAGEMENT MEASUREMENT

(71) Applicant: Shohei Yamada, Camas, WA (US)

(72) Inventor: Shohei Yamada, Camas, WA (US)

(73) Assignee: Sharp Laboratories of America, Inc., Camas, WA (US)

(21) Appl. No.: 13/555,960

(22) Filed: Jul. 23, 2012

Related U.S. Application Data
(63) Continuation-in-part of application No. 13/531,494, filed on Jun. 22, 2012.

(51) Int. Cl. H04W 24/00; H04W 36/00

(52) U.S. Cl. 455/436; 455/67.11

(57) ABSTRACT

A method for performing a measurement procedure is described. Autonomous removal or modification of measurement objects related to the channel state information reference signal (CSI-RS) is performed. Removal or modification of measurement objects related to the channel state information reference signal (CSI-RS) due to a handover or a successful re-establishment is performed.

### RELATED APPLICATION AND PRIORITY CLAIM

This application is a continuation-in part of U.S. patent application Ser. No. 13/531,494, entitled “COORDINATED MULTIPOINT RESOURCE MANAGEMENT MEASUREMENT,” filed Jun. 22, 2012, which is hereby incorporated by reference herein.

### TECHNICAL FIELD

The present invention relates generally to wireless communications and wireless communications-related technology. More specifically, the present invention relates to systems and methods for coordinated multipoint (CoMP) resource management (CRM) measurement.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of cells, each of which may be serviced by a base station. A base station may be a fixed station that communicates with mobile stations.

Various signal processing techniques may be used in wireless communication systems to improve efficiency and quality of wireless communication. In Rel-10, multiple component carriers (CCs) were introduced. The use of coordinated multipoint (CoMP) transmission is considered a major enhancement to Long Term Evolution (LTE) Release 11. Benefits may be realized by improvements to the use of coordinated multipoint (CoMP) transmission. Benefits may also be realized by improved methods for reporting measurement results by a wireless communication device.

### BRIEF DESCRIPTION OF THE DRAWINGS

FIG. 1 is a block diagram illustrating a wireless communication system using uplink control information (UCI) multiplexing;

FIG. 2 is a block diagram illustrating a wireless communication system that may utilize coordinated multipoint (CoMP) transmission;

FIG. 3 is a block diagram illustrating the layers used by a user equipment (UE);

FIG. 4 is a block diagram illustrating a homogenous network with intra-site coordinated multipoint (CoMP);

FIG. 5 is a block diagram illustrating a homogenous network with high Tx power remote radio heads (RRHs);

FIG. 6 is a block diagram illustrating a network with low Tx power remote radio heads (RRHs) within the macrocell coverage;

FIG. 7 is a block diagram illustrating a generalized coordinated multipoint (CoMP) architecture;

FIG. 8 is a block diagram illustrating the structure of a measurement configuration variable;

FIG. 9 is a block diagram illustrating the structure of a measurement report list;

FIG. 10 is a block diagram illustrating an RRC Connection Reconfiguration message structure;

FIG. 11 is a block diagram of a measurement configuration that includes measurement identifications, measurement objects and report configurations;

FIG. 12 is a flow diagram of a method for measurement identity autonomous removal related to coordinated multipoint (CoMP) resource management (CRM) measurements;

FIG. 13 is a flow diagram of a method for measurement identity autonomous removal;

FIG. 14 is a flow diagram of another method for measurement identity autonomous removal;

FIG. 15 is a flow diagram of a method related to actions performed upon handover or re-establishment;

FIG. 16 is a flow diagram of a method for performing actions upon handover or re-establishment;

FIG. 17 is a flow diagram of another method for performing actions upon handover or re-establishment;

FIG. 18 is a flow diagram of a method for updating the measId values in the measIdList within the VarMeasConfig;

FIG. 19 is a flow diagram of a method for performing a linking procedure;

FIG. 20 is a flow diagram of yet another method for performing actions upon handover or re-establishment;

FIG. 21 is a flow diagram of another method for performing a linking procedure;

FIG. 22 is a flow diagram of another method for performing actions upon handover or re-establishment;

FIG. 23 is a flow diagram of a method for measurement object autonomous removal or modification related to coordinated multipoint (CoMP) resource management (CRM) measurements;

FIG. 24 is a flow diagram of a method for measurement object autonomous removal or modification;

FIG. 25 is a flow diagram of another method for performing actions upon handover or re-establishment;

FIG. 26 is a flow diagram of yet another method for performing actions upon handover or re-establishment;

FIG. 27 is a flow diagram of yet another method for performing actions upon handover or re-establishment;

FIG. 28 illustrates various components that may be utilized in a user equipment (UE);

FIG. 29 illustrates various components that may be utilized in an eNB;

FIG. 30 is a block diagram illustrating one configuration of a user equipment (UE) in which systems and methods for coordinated multipoint resource management (CRM) measurement may be implemented; and

FIG. 31 is a block diagram illustrating one configuration of an eNB in which systems and methods for coordinated multipoint resource management (CRM) measurement may be implemented.

### DETAILED DESCRIPTION

A method for performing a measurement object procedure is described. Autonomous modification of measurement objects related to a channel state information reference signal (CSI-RS) is performed.

Performing autonomous modification of measurement objects may include determining whether a measurement object includes information related to a CSI-RS. Performing autonomous modification of measurement objects may also include modifying the measurement object from a measObjectList within a VarMeasConfig if the measurement object includes information related to a CSI-RS. The method may be performed for each measObjectId in the measObjectList within the VarMeasConfig. The method may be performed by a user equipment (UE).

An SCell release procedure may be performed. An SCell addition/modification procedure may also be performed. A measurement configuration procedure may further be performed. The autonomous modification of measurement objects related to a serving frequency may be performed if the concerned serving frequency is not configured. The autonomous modification of measurement objects related to a serving cell may be performed if the concerned serving cell is not configured.

A method for performing a measurement procedure is also described. A modification of measurement objects related to a channel state information reference signal (CSI-RS) due to a handover or a successful re-establishment is performed.

The modification may be performed due to a handover or a successful re-establishment which involves a change of PCell. The modification may also be performed due to a handover or a successful re-establishment which involves a change of primary frequency.

A user equipment (UE) configured for performing a measurement object procedure is described. The user equipment (UE) includes a processor and memory in electronic communication with the processor. Instructions stored in the memory are executable to perform autonomous modification of measurement objects related to a channel state information reference signal (CSI-RS).

A user equipment (UE) configured for performing a measurement procedure is also described. The user equipment (UE) includes a processor and memory in electronic communication with the processor. Instructions stored in the memory are executable to perform a modification of measurement objects related to a channel state information reference signal (CSI-RS) due to a handover or a successful re-establishment.

A method for performing a measurement identity procedure is described. Autonomous removal of measIds related to a channel state information reference signal (CSI-RS) is performed.

Performing autonomous removal of measIds may include determining whether a reportConfig corresponding to a measId concerns an event involving a CSI-RS. Performing autonomous removal of measIds may also include removing the measId from a measIdList within a VarMeasConfig if the reportConfig corresponding to the measId concerns an event involving a CSI-RS. The method may be performed for each measId in the measIdList within the VarMeasConfig. The method may be performed by a user equipment (UE).

An SCell release procedure may be performed. An SCell addition/modification procedure may also be performed. A measurement configuration procedure may further be performed. The autonomous removal of measIds related to a CSI-RS in a serving frequency may be performed if the concerned serving frequency is not configured. The autonomous removal of measIds related to a CSI-RS in a serving cell may be performed if the concerned serving cell is not configured.

A method for performing a measurement procedure is also described. A removal of measIds related to a channel state information reference signal (CSI-RS) due to a handover or a successful re-establishment is performed.

The removal may be performed due to a handover or a successful re-establishment which involves a change of PCell. The removal may also be performed due to a handover or a successful re-establishment which involves a change of primary frequency.

A user equipment (UE) configured for performing a measurement identity procedure is described. The user equipment (UE) includes a processor and memory in electronic communication with the processor. Instructions stored in the memory are executable to perform autonomous removal of measIds related to a channel state information reference signal (CSI-RS).

A user equipment (UE) configured for performing a measurement procedure is also described. The user equipment (UE) includes a processor and memory in electronic communication with the processor. Instructions stored in the memory are executable to perform a removal of measIds related to a channel state information reference signal (CSI-RS) due to a handover or a successful re-establishment.

The 3rd Generation Partnership Project, also referred to as “3GPP,” is a collaboration agreement that aims to define globally applicable technical specifications and technical reports for third and fourth generation wireless communication systems. The 3GPP may define specifications for the next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE and LTE-Advanced standards (e.g., Release-8, Release-9, Release-10 and Release-11). However, the scope of the present disclosure should not be limited in this regard. At least some aspects of the systems and methods disclosed herein may be utilized in other types of wireless communication systems.

In LTE Release-11, the use of coordinated multipoint (CoMP) transmission is a major enhancement. In coordinated multipoint (CoMP) transmission, a user equipment (UE) may be able to receive downlink signals from multiple geographically separated antennas (referred to herein as points). Points may be located on the same base station or on different base stations. Points may be connected to a base station but be in a different physical location than the base station. Furthermore, uplink transmissions by the user equipment (UE) may be received by the multiple points. Sectors of the same site may correspond to different points.

Each point may be controlled by an eNB. There may be one or multiple eNBs. One of the eNBs may be referred to as the serving eNB. The serving eNB may perform most of the processing, such as baseband processing and scheduling. Because some of the antennas might be collocated at an eNB, the eNB may also be a point. The serving eNB may control one or multiple cells. One cell may be designated as the serving cell. The designation of a cell as the serving cell may dynamically change over time. One or more points may be used for transmission or reception in each cell.

An antenna port may be defined such that the channel over which a symbol on the antenna port is conveyed can be inferred from the channel over which another symbol on the same antenna port is conveyed. There may be one resource grid (time-frequency) per antenna port. The antenna port can realize multiple layers for a multiple-input and multiple-output (MIMO) system. The points may be transparent to the user equipment (UE). To a user equipment (UE), antenna ports are distinguishable. An antenna port may be realized by an antenna or set of antennas in one point or a set of antennas in different points. However, points are distinguishable from the perspective of an eNB. Therefore, in a transmission from a point to the user equipment (UE), from the perspective of the eNB, the eNB knows which point(s) are used for an antenna port participating in the transmission.

By coordinating the downlink transmissions from each point to the user equipment (UE), the downlink performance can be significantly increased. Likewise, by coordinating the uplink transmissions from the user equipment (UE), the multiple points may take advantage of the multiple receptions to significantly improve the uplink performance. In coordinated multipoint (CoMP) transmissions, the channel state information (CSI) of each coordinated point may be reported separately or jointly with the same format as Release-10 or new formats.

The use of coordinated multipoint (CoMP) transmission may increase uplink and downlink data transmission rates while ensuring consistent service quality and throughput on LTE wireless broadband networks and 3G networks. Coordinated multipoint (CoMP) transmission may be used on both the uplink and the downlink.

Two major coordinated multipoint (CoMP) transmission methods are under consideration: coordinated scheduling/coordinated beamforming (CS/CB) and joint processing (JP). In coordinated scheduling/coordinated beamforming (CS/CB), the scheduling of the transmission (including beamforming functionality) may be dynamically coordinated between the points (i.e., the points in a serving coordinated multipoint (CoMP) cooperating set) to control/reduce the interference between different coordinated multipoint (CoMP) and non-coordinated multipoint (CoMP) transmissions. In joint processing (JP) (also referred to as joint transmission (JT)), the data may be transmitted by only one transmission point to the user equipment (UE). Dynamic point selection (DPS), including dynamic point blanking, may also be used.

Further, coordinated multipoint (CoMP) resource management (CRM) measurement may be used in a variety of procedures (e.g., radio resource control (RRM) connection procedures). Coordinated multipoint (CoMP) resource management (CRM) measurement may be used in actions related to handover, re-establishment, SCell release and other radio resource control (RRC) type procedures. Implementing coordinated multipoint (CoMP) resource management (CRM) may result in more efficient updating of measurement configurations.

The term “simultaneous” may be used herein to denote a situation where two or more events occur in overlapping time frames. In other words, two “simultaneous” events may overlap in time to some extent, but are not necessarily of the same duration. Furthermore, simultaneous events may or may not begin or end at the same time.

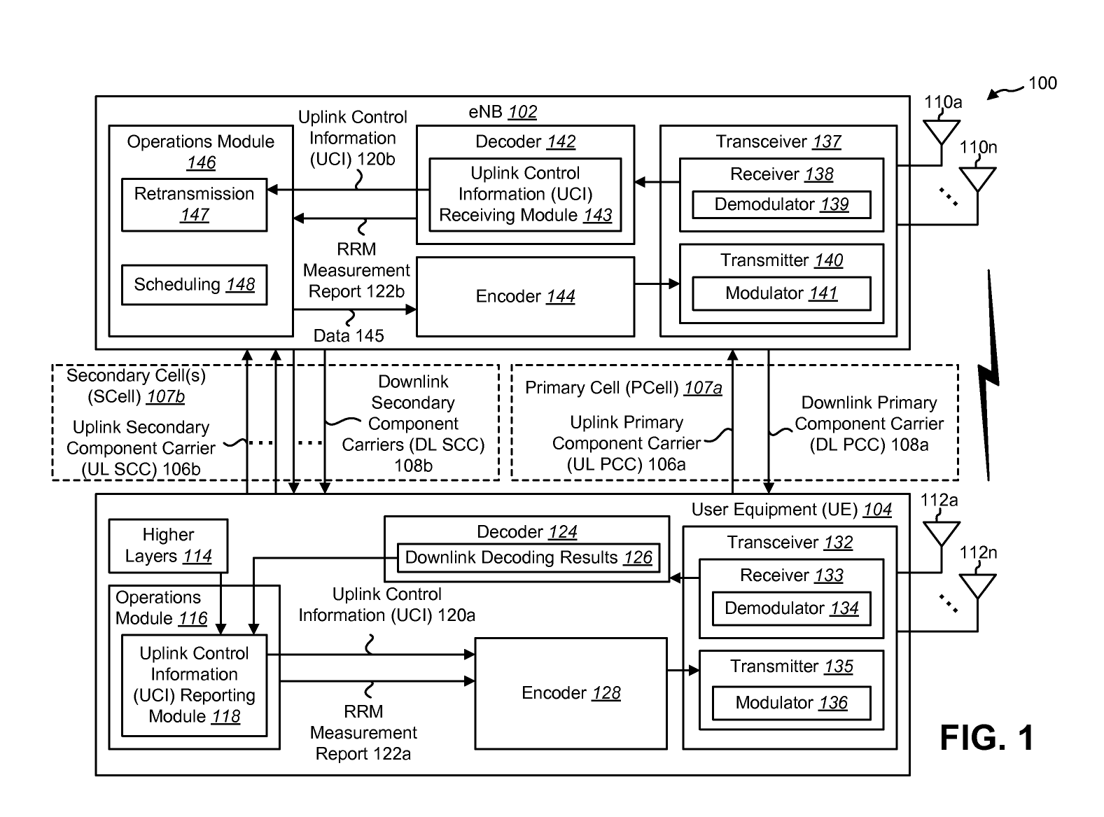

FIG. 1 is a block diagram illustrating a wireless communication system 100 using uplink control information (UCI) multiplexing. An eNB 102 may be in wireless communication with one or more user equipments (UEs) 104. An eNB 102 may be referred to as an access point, a Node B, an evolved Node B, a base station or some other terminology. Likewise, a user equipment (UE) 104 may be referred to as a mobile station, a subscriber station, an access terminal, a remote station, a user terminal, a terminal, a handset, a subscriber unit, a wireless communication device, or some other terminology.

Communication between a user equipment (UE) 104 and an eNB 102 may be accomplished using transmissions over a wireless link, including an uplink and a downlink. The uplink refers to communications sent from a user equipment (UE) 104 to an eNB 102. The downlink refers to communications sent from an eNB 102 to a user equipment (UE) 104. The communication link may be established using a single-input and single-output (SISO), multiple-input and single-output (MISO), single-input and multiple-output (SIMO) or a multiple-input and multiple-output (MIMO) system. A MIMO system may include both a transmitter and a receiver equipped with multiple transmit and receive antennas. Thus, an eNB 102 may have multiple antennas 110a-n and a user equipment (UE) 104 may have multiple antennas 112a-n. In this way, the eNB 102 and the user equipment (UE) 104 may each operate as either a transmitter or a receiver in a MIMO system. One benefit of a MIMO system is improved performance if the additional dimensionalities created by the multiple transmit and receive antennas are utilized.

The user equipment (UE) 104 communicates with an eNB 102 using one or more antenna ports, which may be realized by one or more physical antennas 112a-n. The user equipment (UE) 104 may include a transceiver 132, a decoder 124, an encoder 128 and an operations module 116. The transceiver 132 may include a receiver 133 and a transmitter 135. The receiver 133 may receive signals from the eNB 102 using one or more antennas 112a-n. For example, the receiver 133 may receive and demodulate received signals using a demodulator 134. The transmitter 135 may transmit signals to the eNB 102 using one or more antenna ports, which may be realized by one or more physical antennas 112a-n. For example, the transmitter 135 may modulate signals using a modulator 136 and transmit the modulated signals.

The receiver 133 may provide a demodulated signal to the decoder 124. The user equipment (UE) 104 may use the decoder 124 to decode signals and make downlink decoding results 126. The downlink decoding results 126 may indicate whether data was received correctly. For example, the downlink decoding results 126 may indicate whether a packet was correctly or erroneously received (i.e., positive acknowledgement, negative acknowledgement or discontinuous transmission (no signal)).

The operations module 116 may be a software and/or hardware module used to control user equipment (UE) 104 communications. For example, the operations module 116 may determine when the user equipment (UE) 104 requires resources to communicate with an eNB 102.

In 3^{rd} Generation Partnership Project (3GPP) Long Term Evolution (LTE)—Advanced, additional control feedback will have to be sent on control channels to accommodate MIMO and carrier aggregation. Carrier aggregation refers to transmitting data on multiple component carriers (CCs) (or cells) that are contiguously or separately located. Both the hybrid automatic repeat and request (ARQ) acknowledgement (HARQ-ACK) with positive-acknowledge and negative-acknowledge (ACK/NACK) bits and other control information may be transmitted using the physical uplink control channel (PUCCH) or the physical uplink shared channel (PUSCH). In carrier aggregation (CA), only one uplink component carrier (CC) (or cell) (i.e., PCC or PCell) may be utilized for transmission using the physical uplink control channel (PUCCH). A component carrier (CC) is a carrier frequency to which cells belong.

The user equipment (UE) 104 may transmit uplink control information (UCI) 120a to an eNB 102 on the uplink. The uplink control information (UCI) 120a may include a channel state information (CSI), a scheduling request (SR) and a hybrid automatic repeat request acknowledgement (HARQ-ACK). HARQ-ACK means ACK (positive-acknowledgement) and/or NACK (negative-acknowledgement) and/or DTX (discontinuous transmission) responses for HARQ operation, also known as ACK/NACK. If a transmission is successful, the HARQ-ACK may have a logical value of 1 and if the transmission is unsuccessful, the HARQ-ACK may have a logical value of 0. The channel state information (CSI) includes a channel quality indicator (CQI), a precoding matrix indicator (PMI), a precoding type indicator (PTI) and/or rank indication (RI).

The uplink control information (UCI) 120a may be generated by the uplink control information (UCI) reporting module 118 and transferred to an encoder 128. The operations module 116 may also generate radio resource management (RRM) measurement reports 122a. The radio resource management (RRM) measurement report 122a may be provided to the encoder 128. The encoder 128 may then provide the uplink control information (UCI) 120 for transmission and the radio resource management (RRM) report 122a to the transmitter 135. In one configuration, the radio resource management (RRM) report 122a may be processed in the radio resource control (RRC) layer and the uplink control information (UCI) 120a may be processed in the physical (PHY) layer. A radio resource management (RRM) report may be used in coordinated multipoint (CoMP) resource management (CRM) measuring.

The time and frequency resources may be quantized to create a grid known as the time-frequency grid. In the time domain, 10 milliseconds (ms) is referred to as one radio frame. One radio frame may include 10 subframes, each with a duration of 1 ms, which is the duration of transmission in the uplink and/or downlink. Every subframe may be divided into two slots, each with a duration of 0.5 ms. Each slot may be divided into 7 symbols. The frequency domain may be divided into bands with a 15 kilohertz (kHz) width, referred to as a subcarrier. One resource element has a duration of one symbol in the time domain and the bandwidth of one subcarrier in the frequency domain.

The minimum amount of resource that can be allocated for the transmission of information in the uplink or downlink in any given subframe is two resource blocks (RBs), with one RB at each slot. One RB has a duration of 0.5 ms (7 symbols or one slot) in the time domain and a bandwidth of 12 subcarriers (180 kHz) in the frequency domain. At any given subframe, a maximum of two RBs (one RB at each slot) can be used by a given user equipment (UE) 104 for the transmission of uplink control information (UCI) in the physical uplink control channel (PUCCH).

In LTE Release-8, only one uplink component carrier (CC) 106 or cell 107 and one downlink component carrier (CC) 108 or cell 107 can be used for transmission to and reception from each user equipment (UE) 104.

In 3GPP Long Term Evolution (LTE) Release-10 (LTE-A or Advanced EUTRAN), carrier aggregation was introduced. Carrier aggregation may also be referred to as cell aggregation. Carrier aggregation is supported in both the uplink and the downlink with up to five component carriers (CCs) 106, 108. Each component carrier (CC) 106, 108 or cell 107 may have a transmission bandwidth of up to 110 resource blocks (i.e., up to 20 megahertz (MHz)). In carrier aggregation, two or more component carriers (CCs) 106, 108 are aggregated to support wider transmission bandwidths up to one hundred megahertz (MHz). A user equipment (UE) 104 may simultaneously receive and/or transmit on one or multiple component carriers (CCs) 106, 108, depending on the capabilities of the user equipment (UE) 104.

A user equipment (UE) 104 may communicate with an eNB 102 using multiple component carriers (CCs) 108 at the same time. For example, a user equipment (UE) 104 may communicate with an eNB 102 using a primary cell (PCell) 107a while simultaneously communicating with the eNB 102 using secondary cell(s) (SCell) 107b. Similarly, an eNB 102 may communicate with a user equipment (UE) 104 using multiple component carriers (CCs) 108 at the same time. For example, an eNB 102 may communicate with a user equipment (UE) 104 using a primary cell (PCell) 107a while simultaneously communicating with the user equipment (UE) 104 using secondary cell(s) (SCell) 107b.

An eNB 102 may include a transceiver 137 that includes a receiver 138 and a transmitter 140. An eNB 102 may additionally include a decoder 142, an encoder 144 and an operations module 146. An eNB 102 may receive uplink control information (UCI) 120b and radio resource management (RRM) measurement reports 122b using its one or more antenna ports, which may be realized by one or more physical antennas 110a-n, and its receiver 138. The receiver 138 may use the demodulator 139 to demodulate the uplink control information (UCI) 120b and the radio resource management (RRM) measurement reports 122b.

The decoder 142 may include an uplink control information (UCI) receiving module 143. An eNB 102 may use the uplink control information (UCI) receiving module 143 to decode and interpret the uplink control information (UCI) 120b received by the eNB 102. The eNB 102 may use the decoded uplink control information (UCI) 120b to perform certain operations, such as retransmit one or more packets based on scheduled communication resources for the user equipment (UE) 104. The decoder 142 may also decode the radio resource management (RRM) measurement report 122b. The radio resource management (RRM) measurement report 122b may be defined for the purpose of inter-cell mobility management in the radio resource control (RRC) layer. The radio resource management (RRM) measurement report 122b may be used to efficiently select coordinated multipoint (CoMP) transmission points and/or to select efficient channel state information (CSI) measurement sets in the physical layer.

The operations module 146 may include a retransmission module 147 and a scheduling module 148. The retransmission module 147 may determine which packets to retransmit (if any) based on the uplink control information (UCI) 120b. The scheduling module 148 may be used by the eNB 102 to schedule communication resources (e.g., bandwidth, time slots, frequency channels, spatial channels, etc.). The scheduling module 148 may use the uplink control information (UCI) 120b to determine whether (and when) to schedule communication resources for the user equipment (UE) 104.

The operations module 146 may provide data 145 to the encoder 144. For example, the data 145 may include packets for retransmission and/or a scheduling grant for the user equipment (UE) 104. The encoder 144 may encode the data 145, which may then be provided to the transmitter 140. The transmitter 140 may modulate the encoded data using the modulator 141. The transmitter 140 may transmit the modulated data to the user equipment (UE) 104 using one or more antenna ports, which may be realized by the one or more physical antennas 110a-n.

When carrier aggregation is configured, a user equipment (UE) 104 may have only one radio resource control (RRC) connection with the network. At the radio resource control (RRC) connection establishment/re-establishment/handover, one serving cell 107 (i.e., the primary cell (PCell) 107a) provides the non-access stratum (NAS) mobility information (e.g., Tracking Area Identity (TAI)) and the security input.

In the downlink, the component carrier (CC) 108 corresponding to the primary cell (PCell) 107a is the downlink primary component carrier (DL PCC) 108a. In the uplink, the component carrier (CC) 106 corresponding to the primary cell (PCell) 107a is the uplink primary component carrier (UL PCC) 106a. Depending on the capabilities of the user equipment (UE) 104, one or more secondary component carriers (SCC) 106b, 108b or secondary cells (SCell) 107b may be configured to form a set of serving cells with the primary cell (PCell) 107a. In the downlink, the component carrier (CC) 108 corresponding to the secondary cell (SCell) 107b is the downlink secondary component carrier (DL SCC) 108b. In the uplink, the component carrier (CC) 106 corresponding to the secondary cell (SCell) 107b is the uplink secondary component carrier (UL SCC) 106b. The number of downlink component carriers (CCs) 108 may be different from the number of uplink component carriers (CCs) 106 because multiple cells may share one uplink component carrier (CC) 106.

If carrier aggregation is configured, a user equipment (UE) 104 may have multiple serving cells: a primary cell (PCell) 107a and one or more secondary cells (SCell) 107b. From a network perspective, a serving cell 107 may be used as the primary cell (PCell) 107a by one user equipment (UE) 104 and used as a secondary cell (SCell) 107b by another user equipment (UE) 104. If carrier aggregation is not configured, a primary cell (PCell) 107a operates a single serving cell. There may be one or more secondary cells (SCell) 107b in addition to the primary cell (PCell) 107a if carrier aggregation is configured. One benefit of using carrier aggregation is that additional downlink and/or uplink data may be transmitted. As a result of the additional downlink data, additional uplink control information (UCI) 120 may be needed.

A number of spatial channels may be available on each serving cell 107 by using multiple antenna ports at a transmitter and a receiver. Therefore, multiple codewords (up to two codewords) may be transmitted simultaneously.

A channel state information (CSI) report may be generated for each component carrier (CC) 106, 108 or cell 107. In Rel-10, channel state information (CSI) reporting for up to five downlink component carriers (CCs) 108 may be supported. A channel state information (CSI) report may be used to inform the eNB 102 to adjust the transmission rate (modulation scheme and coding rate) dynamically based on the existing channel conditions at the user equipment (UE) 104. For example, if a channel state information (CSI) report indicates a good channel quality at the user equipment (UE) 104, the eNB 102 may select a higher order modulation and coding rate, thereby achieving a higher transmission rate for the downlink transmission of data on the physical downlink shared channel (PDSCH). If a channel state information (CSI) report indicates a poor channel quality at the user equipment (UE) 104, the eNB 102 may select a lower order modulation and coding rate, thereby achieving higher reliability for the transmission.

The channel state information (CSI) may include a channel quality indicator (CQI), a precoding matrix indicator (PMI), a precoding type indicator (PTI) and/or rank indication (RI). A channel state information (CSI) report may be referred to as a rank indication (RI) report if the channel state information (CSI) report only includes rank indication (RI). A channel state information (CSI) report may be referred to as a channel quality indicator (CQI) report if the channel state information (CSI) report only includes a channel quality indicator (Cal). A channel state information (CSI) report may be referred to as a precoding matrix indicator (PMI) report if the channel state information (CSI) report only includes a precoding matrix indicator (PMI).

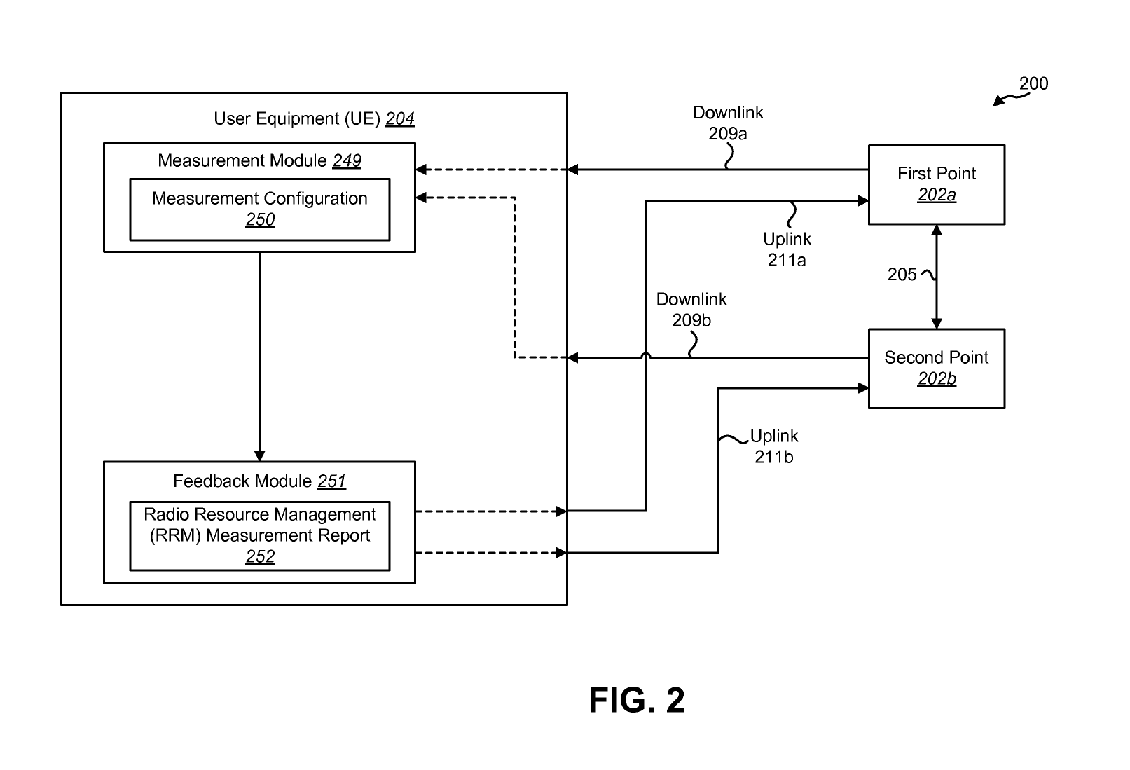

FIG. 2 is a block diagram illustrating a wireless communication system 200 that may utilize coordinated multipoint (CoMP) transmission. The wireless communication system 200 may include a first point 202a in communication with a user equipment (UE) 204 and a second point 202b in communication with the user equipment (UE) 204. Additional points (not shown) may also be in communication with the user equipment (UE) 204.

All points 202 communicating with a user equipment (UE) 204 may be referred to as transmission points 202. For simplicity, reference is also made herein to only a single transmission point 202, even though there may be multiple transmission points 202. There may be a communication link 205 between each of the points 202.

As used herein, a cooperating set refers to a set of geographically separated points 202 directly and/or indirectly participating in data transmission to a user equipment (UE) 204 in a time-frequency resource. The cooperating set may or may not be transparent to the user equipment (UE) 204. Thus, the set of transmission points 202 is a subset of the cooperating set.

A point 202 may be controlled by a base station (such as an eNB 102). Communication between a user equipment (UE) 204 and a point 202 may be accomplished using transmissions over a wireless link, including an uplink 211a-b and a downlink 209a-b. The uplink 211 refers to communications sent from a user equipment (UE) 204 to one or more points 202 (referred to as reception points 202). The downlink 209 refers to communications sent from one or more points 202 (referred to as transmission points 202) to a user equipment (UE) 204. The set of reception points 202 may include none, some or all of the points 202 in the set of transmission points 202. Likewise, the set of transmission points 202 may include none, some or all of the points 202 in the set of reception points 202. A point 202 and a user equipment (UE) 204 may each operate as either a transmitter or a receiver in a MIMO system.

There has recently been a lot of interest in coordinated multipoint (CoMP) transmission schemes where multiple transmission points 202 cooperate. There has also been discussion on how to improve the feedback scheme for both coordinated multipoint (CoMP) transmission and multiuser MIMO schemes. The point 202 may make a decision concerning the use of coordinated multipoint (CoMP) transmission and the coordinated multipoint (CoMP) transmission method used based on feedback from the user equipment (UE) 204. Depending on the channel conditions observed by a user equipment (UE) 204, coordinated multipoint (CoMP) transmission operation and the coordinated multipoint (CoMP) transmission method of each cell may be configured dynamically and independently.

The user equipment (UE) 204 may include a measurement module 249. The measurement module 249 may include a measurement configuration 250. The measurement configuration 250 may define the settings for the user equipment (UE) 204 to generate and transmit a measurement report 252 to the network. The measurement report 252 may be generated by a feedback module 251 on the user equipment (UE) 204. The user equipment (UE) 204 may then transmit the measurement report to the E-UTRAN (e.g., the serving eNB 102, a neighbor eNB 102 and/or a network). More specifically, in Rel-11, coordinated multipoint (CoMP) resource management (CRM) measurement is introduced to achieve setting efficient coordinated multipoint (CoMP) transmission points and/or to choose an efficient channel state information (CSI) measurement set in the physical layer. In Rel-10, radio resource management (RRM) measurement can only support cell-specific reference signal (CRS) based reference signal received power (RSRP)/reference signal received quality (RSRQ) measurement.

For coordinated multipoint (CoMP) resource management (CRM) measurement, one or more channel state information reference signals (CSI-RSs) are needed to measure the channels of transmission points. The user equipment (UE) 204 does not need to know the linking between transmission points 202 and channel state information reference signals (CSI-RSs). From measurement reports of CSI-RSs, the E-UTRAN can know the conditions of transmission points 202, because the E-UTRAN knows the linking between transmission points 202 and channel state information reference signals (CSI-RSs). Coordinated multipoint (CoMP) resource management (CRM) measurement may generate a radio resource management (RRM) measurement report 252 that is then transmitted by the user equipment (UE) 204 to the network. Channel state information reference signal (CSI-RS) based radio resource management (RRM) measurement may be used for both coordinated multipoint (CoMP) resource management (CRM) measurement and other purposes (e.g., mobility, load sharing, radio resource management). Therefore, configurations for coordinated multipoint (CoMP) resource management (CRM) measurement may be considered as configurations for channel state information reference signal (CSI-RS) based radio resource management (RRM) measurement.

In Rel-10, radio resource management (RRM) measurement is defined primarily for inter-cell mobility management in the radio resource control (RRC) layer. The user equipment (UE) 204 may receive a measurement configuration 250 from the E-UTRAN (e.g., the serving eNB 102, a neighbor eNB 102 and/or a network). The E-UTRAN may provide the measurement configuration applicable for a user equipment (UE) 204 in RRC_CONNECTED by means of dedicated signaling (i.e., using the RRCConnectionReconfiguration message).

The measurement configuration 250 may instruct the user equipment (UE) 204 to obtain intra-frequency measurements (i.e., measurements at the downlink carrier frequencies of the serving cells 107), inter-frequency measurements (i.e., measurements at frequencies that differ from any of the downlink carrier frequencies of the serving cells 107) and inter-RAT measurements.

A measurement configuration 250 may include measurement objects, reporting configurations, measurement identities, quantity configurations and measurement gaps. Measurement objects refer to the objects on which the user equipment (UE) 204 performs measurements. For intra-frequency and inter-frequency measurements, a measurement object may be a single E-UTRA carrier frequency. Associated with this carrier frequency, the E-UTRAN may configure a list of cell specific offsets and a list of blacklisted cells. Blacklisted cells are those cells that are not considered in event evaluation or measurement reporting.

Reporting configurations may include reporting criterion that triggers the user equipment (UE) 204 to send a measurement report 252. The reporting criterion may be either periodical or a single event description. Reporting configurations may also include the reporting format. The reporting format may define the quantities that the user equipment (UE) 204 includes in a measurement report 252 and the associated information (e.g., the number of cells to report).

Measurement identities may link one measurement object with one reporting configuration. By configuring multiple measurement identities, it is possible to link more than one measurement object to the same reporting configuration. It is also possible to link more than one reporting configuration to the same measurement object. The measurement identity may be used as a reference number in the measurement report 252.

One quantity configuration may be configured per radio access technology (RAT) type. The quantity configuration may define the measurement quantities and the associated filtering used for all event evaluations and related reporting of that measurement type. One filter may be configured per measurement quantity. Measurement gaps may refer to periods that the user equipment (UE) 204 may use to perform measurements (i.e., no uplink 211 or downlink 209 transmissions are scheduled during the measurement gap).

The E-UTRAN may only configure a single measurement object for a given frequency. In other words, it is not possible to configure two or more measurement objects for the same frequency with different associated parameters (e.g., different offsets and/or blacklists). The E-UTRAN may configure multiple instances of the same event (e.g., by configuring two reporting configurations with different thresholds).

The user equipment (UE) 204 may maintain a single measurement configuration 250. The measurement configuration 250 may include a single measurement object list, a single reporting configuration list and a single measurement identities list. The measurement object list may include measurement objects that are specified per radio access technology (RAT) type. The measurement objects may include intra-frequency objects (i.e., objects corresponding to the serving frequencies), inter-frequency objects and inter-RAT objects. Similarly, the reporting configuration list may include E-UTRA and inter-RAT reporting configurations. Some reporting configurations may not be linked to a measurement object. Likewise, some measurement objects may not be linked to a reporting configuration.

The measurement procedures in a measurement configuration 250 may distinguish between the serving cell(s) 107 (the PCell 107a and one or more SCells 107b if configured for a user equipment (UE) 204 that supports carrier aggregation), the listed cells (the cells listed within the measurement objects) and detected cells (the cells that are not listed within the measurement objects but are detected by the user equipment (UE) 204 on the carrier frequencies indicated by the measurement objects). For E-UTRA, the user equipment (UE) 204 may measure and report on the serving cells 107, the listed cells and the detected cells.

It may be required that the user equipment (UE) 204 be able to identify new intra-frequency cells and perform reference signal received power (RSRP) measurements of identified intra-frequency cells without an explicit intra-frequency neighbor cell list that includes the physical layer cell identities. During the RRC_CONNECTED state, the user equipment (UE) 204 may continuously measure identified intra-frequency cells and search for and identify new intra-frequency cells. It may also be required that the user equipment (UE) 204 be able to identify new inter-frequency cells. The user equipment (UE) 204 may perform reference signal received power (RSRP) measurements of identified inter-frequency cells if carrier frequency information is provided by the PCell 107a, even if no explicit neighbor list with physical layer cell identities is provided.

For all measurements performed by the measurement module 249, the user equipment (UE) 204 may apply layer 3 filtering before using the measured results for evaluation of reporting criteria and/or for measurement reporting. Whenever the user equipment (UE) 204 has a measurement configuration 250, the user equipment (UE) 204 may perform reference signal received power (RSRP) measurements and reference signal received quality (RSRQ) measurements for each serving cell 107.

The user equipment (UE) 204 may perform measurements on the frequencies and radio access technologies (RATs) indicated in the measurement configuration 250 if a measurement gap configuration is setup or if the user equipment (UE) 204 does not require measurement gaps to perform the specific measurement. The user equipment (UE) 204 may also perform measurements on the frequencies and radio access technologies (RATs) indicated in the measurement configuration 250 if s-Measure is not configured or if s-Measure is configured and the PCell 107a reference signal received power (RSRP) after layer 3 filtering is lower than the value of s-Measure.

As discussed above, in Rel-10 radio resource management (RRM) measurement, reference signal received power (RSRP) and reference signal received quality (RSRQ) are measured for the cell-specific reference signal (CRS) but not for the channel state information reference signal (CSI-RS). In Rel-11 radio resource management (RRM) measurement, reference signal received power (RSRP) and/or reference signal received quality (RSRQ) are measured for both the cell-specific reference signal (CRS) and the channel state information reference signal (CSI-RS).

For the measurement ID (measId) for which the measurement reporting procedure was triggered, the user equipment (UE) 204 may set the measurement results (measResults) within the MeasurementReport message and submit the MeasurementReport message to lower layers for transmission from the user equipment (UE) 204 to the E-UTRAN.

The RRCConnectionReconfiguration message is the command to modify an RRC connection. The RRCConnectionReconfiguration message may convey information for measurement configuration 250, mobility control, radio resource configuration (including resource blocks (RBs), the medium access control (MAC) main configuration and the physical channel configuration) any associated dedicated NAS information and security configuration. RRCConnectionReconfiguration is given below:

RRCConnectionReconfiguration-r8-IEs ::= SEQUENCE {

| | | |
|---|---|---|
| measConfig | MeasConfig | OPTIONAL, - |
| - Need ON | | |
| mobilityControlInfo | MobilityControlInfo | OPTIONAL, - |
| - Cond HO | | |

| dedicatedInfoNASList | SEQUENCE (SIZE(1..maxDRB)) OF | |
|---|---|---|
| | DedicatedInfoNAS | OPTIONAL, -- |

| | |
|---|---|
| Cond nonHO | |
| radioResourceConfigDedicated | RadioResourceConfigDedicatedOPTIONAL, -- |
| Cond HO-toEUTRA | |

| | | |
|---|---|---|
| securityConfigHO | SecurityConfigHO | OPTIONAL, -- |
| Cond HO | | |

| | |
|---|---|
| nonCriticalExtension | RRCConnectionReconfiguration-v890-IEs |
| OPTIONAL | |
| }. | |

The information element (IE) MeasConfig may specify measurements to be performed by the user equipment (UE) 204. The information element (IE) MeasConfig may also cover intra-frequency, inter-frequency and inter-RAT mobility as well as the configuration of measurement gaps. The information element (IE) MeasConfig is given below:

| | |
|---|---|
| -- ASN1START | |
| MeasConfig ::= | SEQUENCE { |
| -- Measurement objects | |

| | |
|---|---|
| measObjectToRemoveList | MeasObjectToRemoveList |
| OPTIONAL, -- Need ON | |
| measObjectToAddModList | MeasObjectToAddModList |
| OPTIONAL, -- Need ON | |
| -- Reporting configurations | |

| | | |
|---|---|---|
| reportConfigToRemoveList | ReportConfigToRemoveList | OPTIONAL, |
| -- Need ON | | |
| reportConfigToAddModList | ReportConfigToAddModList | OPTIONAL, |
| -- Need ON | | |
| -- Measurement identities | | |

| | |
|---|---|
| measIdToRemoveList | MeasIdToRemoveList |
| OPTIONAL, -- Need ON | |
| measIdToAddModList | MeasIdToAddModList |
| OPTIONAL, -- Need ON | |
| -- Other parameters | |

| | | |
|---|---|---|
| quantityConfig | QuantityConfig | OPTIONAL, - |
| - Need ON | | |

| | | |
|---|---|---|
| measGapConfig | MeasGapConfig | OPTIONAL, |
| -- Need ON | | |

| | | |
|---|---|---|
| s-Measure | RSRP-Range | OPTIONAL, - |
| - Need ON | | |

| | |
|---|---|
| preRegistrationInfoHRPD | PreRegistrationInfoHRPD |
| OPTIONAL, -- Need OP | |

| | |
|---|---|
| speedStatePars | CHOICE { |

| | |
|---|---|
| release | NULL, |

| | |
|---|---|
| setup | SEQUENCE { |

| | |
|---|---|
| mobilityStateParameters | MobilityStateParameters, |

| | |
|---|---|
| timeToTrigger-SF | SpeedStateScaleFactors |
| } | |

| | |
|---|---|
| } | OPTIONAL, -- |
| Need ON | |
| ... | |
| } | |

| | |
|---|---|
| MeasIdToRemoveList ::= | SEQUENCE (SIZE (1..maxMeasId)) OF MeasId |

| | |
|---|---|
| MeasObjectToRemoveList ::= | SEQUENCE (SIZE (1..maxObjectId)) OF |
| MeasObjectId | |

| | |
|---|---|
| ReportConfigToRemoveList ::= | SEQUENCE (SIZE (1..maxReportConfigId)) OF |
| ReportConfigId | |
| -- ASN1STOP. | |

The information element (IE) Measld may be used to identify a measurement configuration 250 (i.e., the linking of a measurement object and a reporting configuration). The information element (IE) MeasIdToAddModList concerns a list of measurement identities to add to or modify the measurement configuration 250. For each entry in MeasIdToAddModList, the measId, the associated measObjectId and the associated reportConfigId are included. The information element (IE) MeasIdToAddModList is given below:

| | |
|---|---|
| -- ASN1START | |
| MeasIdToAddModList ::= | SEQUENCE (SIZE (1..maxMeasId)) OF |
| MeasIdToAddMod | |

MeasIdToAddMod ::= SEQUENCE {

| | |
|---|---|
| measId | MeasId, |
| measObjectId | MeasObjectId, |
| reportConfigId | ReportConfigId |
| } | |
| -- ASN1STOP. | |

The information element (IE) MeasObjectToAddModList concerns a list of measurement objects to add or modify. The information element (IE) MeasObjectToAddModList may link measObjectId and measObject. The information element (IE) MeasObjectToAddModList is given below:

| | |
|---|---|
| -- ASN1START | |
| MeasObjectToAddModList ::= | SEQUENCE (SIZE (1..maxObjectId)) |
| OF MeasObjectToAddMod | |

MeasObjectToAddMod ::= SEQUENCE {

| | |
|---|---|
| measObjectId | MeasObjectId, |
| measObject | CHOICE { |

| | |
|---|---|
| measObjectEUTRA | MeasObjectEUTRA, |
| measObjectUTRA | MeasObjectUTRA, |
| measObjectGERAN | MeasObjectGERAN, |
| measObjectCDMA2000 | MeasObjectCDMA2000, |
| ... | |
| } | |
| } | |
| -- ASN1STOP. | |

The information element (IE) MeasObjectEUTRA specifies information applicable for intra-frequency or intra-frequency E-UTRA cells. The information element (IE) MeasObjectEUTRA is given below:

| | |
|---|---|
| -- ASN1START | |
| MeasObjectEUTRA ::= | SEQUENCE { |
| carrierFreq | ARFCN-ValueEUTRA, |
| allowedMeasBandwidth | AllowedMeasBandwidth, |
| presenceAntennaPort1 | PresenceAntennaPort1, |
| neighCellConfig | NeighCellConfig, |

| | | |
|---|---|---|
| offsetFreq | Q-OffsetRange | DEFAULT dB0, |
| -- Cell list | | |

| | | |
|---|---|---|
| cellsToRemoveList | CellIndexList | OPTIONAL, -- |
| Need ON | | |

| | | |
|---|---|---|
| cellsToAddModList | CellsToAddModList | OPTIONAL, - |
| - Need ON | | |
| -- Black list | | |

| | | |
|---|---|---|
| blackCellsToRemoveList | CellIndexList | OPTIONAL, -- |
| Need ON | | |

| | | |
|---|---|---|
| blackCellsToAddModList | BlackCellsToAddModList | OPTIONAL, - |
| - Need ON | | |

| | | |
|---|---|---|
| cellForWhichToReportCGI | PhysCellId | OPTIONAL, - |
| - Need ON | | |
| ..., | | |

| | | |
|---|---|---|
| [[measCycleSCell-r10 | MeasCycleSCell-r10 | OPTIONAL, -- |
| Need ON | | |

measSubframePatternConfigNeigh-r10 MeasSubframePatternConfigNeigh-r10

| | |
|---|---|
| OPTIONAL | -- Need ON |
| ]] | |
| } | |
| CellsToAddModList ::= | SEQUENCE (SIZE (1..maxCellMeas)) OF |
| CellsToAddMod | |

CellsToAddMod ::= SEQUENCE {

| | |
|---|---|
| cellIndex | INTEGER (1..maxCellMeas), |
| physCellId | PhysCellId, |
| cellIndividualOffset | Q-OffsetRange |
| } | |
| BlackCellsToAddModList ::= | SEQUENCE (SIZE (1..maxCellMeas)) OF |
| BlackCellsToAddMod | |

BlackCellsToAddMod ::= SEQUENCE {

| | |
|---|---|
| cellIndex | INTEGER (1..maxCellMeas), |

| | |
|---|---|
| physCellIdRange | PhysCellIdRange |
| } | |

| | |
|---|---|
| MeasCycleSCell-r10 ::= | ENUMERATED {sf160, sf256, sf320, sf512, |

sf640, sf1024, sf1280, spare1}

MeasSubframePatternConfigNeigh-r10 ::= CHOICE {

| | |
|---|---|
| release | NULL, |

| | |
|---|---|
| setup | SEQUENCE { |

| | |
|---|---|
| measSubframePatternNeigh-r10 | MeasSubframePattern-r10, |
| measSubframeCellList-r10 | MeasSubframeCellList-r10 OPTIONAL |
| -- Cond measSubframe | |
| } | |
| } | |

MeasSubframeCellList-r10 ::= SEQUENCE (SIZE (1..maxCellMeas)) OF
PhysCellIdRange
-- ASN1STOP.

The information element (IE) ReportConfigEUTRA specifies criteria for triggering an E-UTRA measurement reporting event. The trigger type may be set to event trigger or periodic trigger. The E-UTRA measurement reporting events are listed below:
Event A1: Serving becomes better than absolute threshold;
Event A2: Serving becomes worse than absolute threshold;
Event A3: Neighbour becomes amount of offset better than PCell;
Event A4: Neighbour becomes better than absolute threshold;
Event A5: PCell becomes worse than absolute threshold1 AND Neighbour becomes better than another absolute threshold2;
Event A6: Neighbour becomes amount of offset better than SCell.

The information element (IE) ReportConfigEUTRA is given below:

| -- ASN1START | | |
|---|---|---|
| ReportConfigEUTRA ::= | SEQUENCE { | |
| triggerType | CHOICE { | |
| event | SEQUENCE { | |
| eventId | CHOICE { | |
| eventA1 | SEQUENCE { | |
| a1-Threshold | ThresholdEUTRA | |
| }, | | |
| eventA2 | SEQUENCE { | |
| a2-Threshold | ThresholdEUTRA | |
| }, | | |
| eventA3 | SEQUENCE { | |
| a3-Offset | INTEGER (−30..30), | |
| reportOnLeave | BOOLEAN | |
| }, | | |
| eventA4 | SEQUENCE { | |
| a4-Threshold | ThresholdEUTRA | |
| }, | | |
| eventA5 | SEQUENCE { | |
| a5-Threshold1 | ThresholdEUTRA, | |
| a5-Threshold2 | ThresholdEUTRA | |
| }, | | |
| ..., | | |
| eventA6-r10 | SEQUENCE { | |
| a6-Offset-r10 | INTEGER (−30..30), | |
| a6-ReportOnLeave-r10 | BOOLEAN | |
| } | | |
| }, | | |
| hysteresis | Hysteresis, | |
| timeToTrigger | TimeToTrigger | |
| }, | | |
| periodical | SEQUENCE { | |
| purpose | ENUMERATED { | |
| | reportStrongestCells, reportCGI} | |
| } | | |
| }, | | |
| triggerQuantity | ENUMERATED {rsrp, rsrq}, | |
| reportQuantity | ENUMERATED {sameAsTriggerQuantity, both}, | |
| maxReportCells | INTEGER (1..maxCellReport), | |
| reportInterval | ReportInterval, | |
| reportAmount | ENUMERATED {r1, r2, r4, r8, r16, r32, r64, infinity}, | |
| ..., | | |
| [[ si-RequestForHO-r9 | ENUMERATED {setup} | OPTIONAL, - |
| - Cond reportCGI | | |
| ue-RxTxTimeDiffPeriodical-r9 | ENUMERATED {setup} | OPTIONAL - |
| - Need OR | | |
| ]], | | |
| [[ includeLocationInfo-r10 | ENUMERATED {true} | OPTIONAL, - |
| - Cond reportMDT | | |
| reportAddNeighMeas-r10 | ENUMERATED {setup} | OPTIONAL |
| -- Need OR | | |
| ]] | | |
| } | | |
| ThresholdEUTRA ::= | CHOICE{ | |
| threshold-RSRP | RSRP-Range, | |
| threshold-RSRQ | RSRQ-Range | |
| } | | |
| -- ASN1STOP. | | |

The information element (IE) ReportConfigld may be used to identify a measurement reporting configuration. The information element (IE) MeasResults covers measured results for intra-frequency, inter-frequency and inter-RAT mobility. The information element (IE) MeasResults may include measId, the measurement results of PCell 107a and optionally the measurement results of the neighbor cell and the SCells 107b.

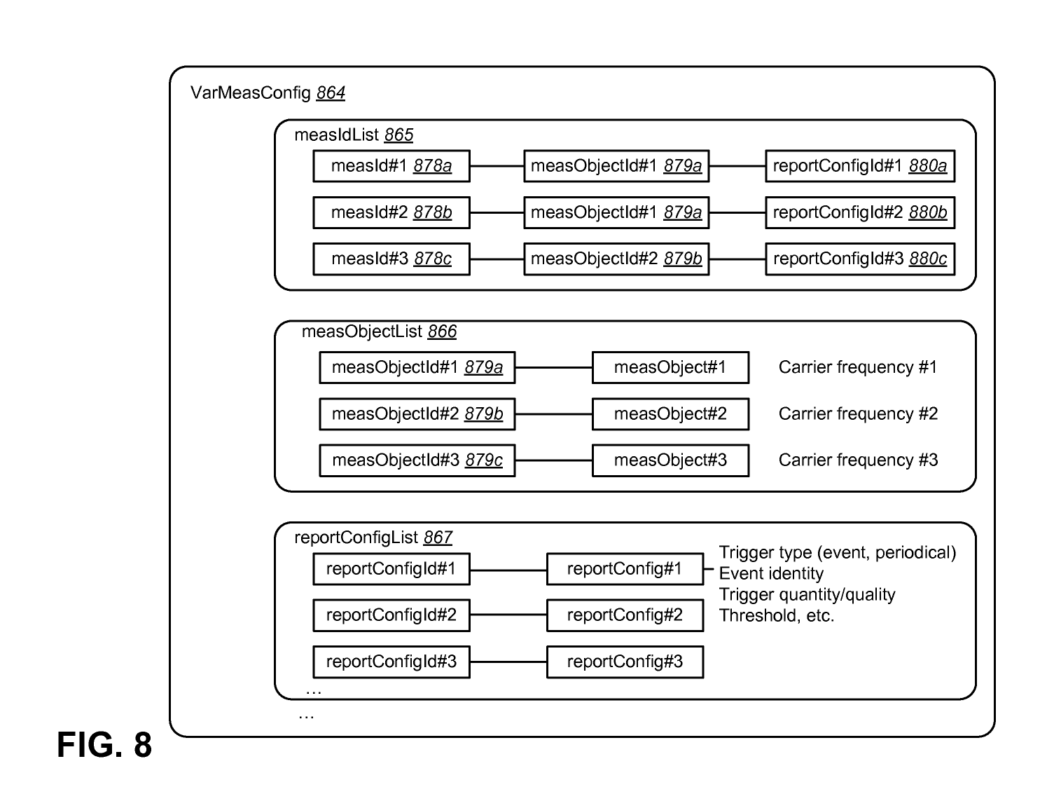

The user equipment (UE) 204 may include a variable VarMeasConfig. The variable VarMeasConfig is discussed in additional detail below in relation to FIG. 8. The variable VarMeasConfig may include the accumulated configuration of the measurements to be performed by the user equipment (UE) 204, including intra-frequency, inter-frequency and inter-RAT mobility related measurements. The VarMeasConfig variable is given below:

| -- ASN1START | | |
|---|---|---|
| VarMeasConfig ::= | SEQUENCE { | |
| -- Measurement identities | | |
| measIdList | MeasIdToAddModList | |
| OPTIONAL, | | |
| -- Measurement objects | | |
| measObjectList | MeasObjectToAddModList | |
| OPTIONAL, | | |
| -- Reporting configurations | | |
| reportConfigList | ReportConfigToAddModList | OPTIONAL, |
| -- Other parameters | | |
| quantityConfig | QuantityConfig | OPTIONAL, |
| s-Measure | INTEGER (−140..−44) | OPTIONAL, |
| speedStatePars | CHOICE { | |
| release | NULL, | |
| setup | SEQUENCE { | |
| mobilityStateParameters | MobilityStateParameters, | |
| timeToTrigger-SF | SpeedStateScaleFactors | |
| } | | |

| | |
|---|---|
| } | OPTIONAL |
| } | |
| -- ASN1STOP. | |

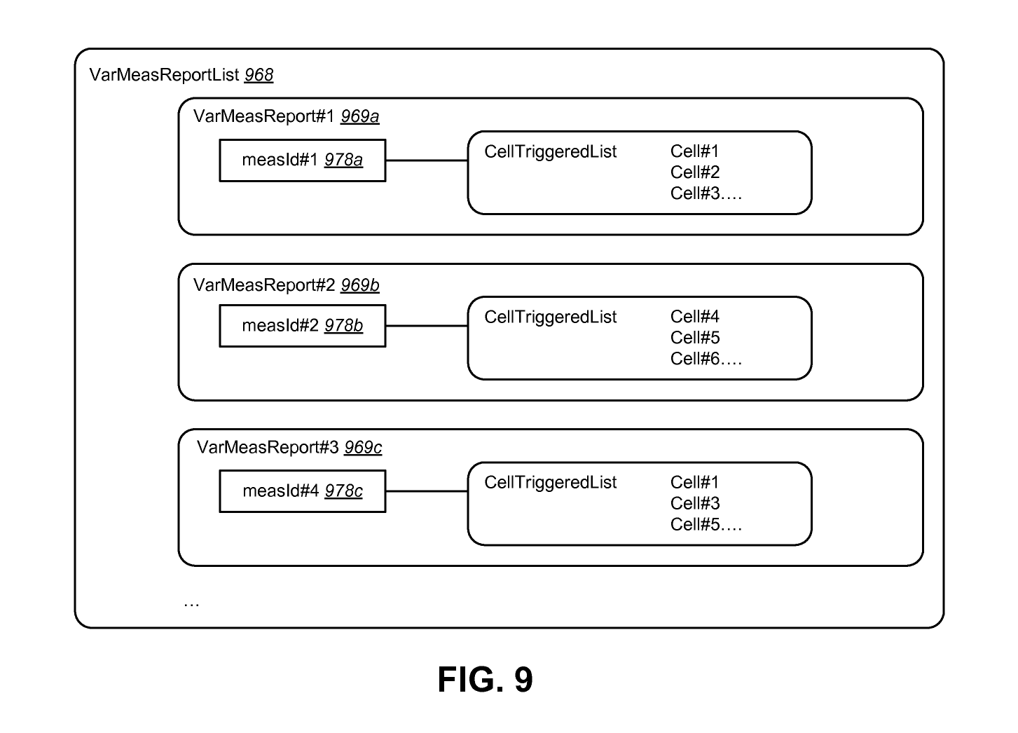

The user equipment (UE) 204 may also include a variable VarMeasReportList. The variable VarMeasReportList is discussed in additional detail below in relation to FIG. 9. The variable VarMeasReportList may include information about the measurements for which the triggering conditions have been met. The VarMeasReportList variable is given below:

| | |
|---|---|
| -- ASN1START | |
| VarMeasReportList ::= | SEQUENCE (SIZE (1..maxMeasId)) OF |
| VarMeasReport | |
| VarMeasReport ::= | SEQUENCE { |

-- List of measurement that have been triggered

| | | |
|---|---|---|
| measId | MeasId, | |
| cellsTriggeredList | CellsTriggeredList | OPTIONAL, |

| | |
|---|---|
| numberOfReportsSent | INTEGER |
| } | |
| CellsTriggeredList ::= | SEQUENCE (SIZE (1..maxCellMeas)) OF |
| | CHOICE { |
| physCellIdEUTRA | PhysCellId, |
| physCellIdUTRA | CHOICE { |
| fdd | PhysCellIdUTRA-FDD, |
| tdd | PhysCellIdUTRA-TDD |
| }, | |
| physCellIdGERAN | SEQUENCE { |
| carrierFreq | CarrierFreqGERAN, |
| physCellId | PhysCellIdGERAN |
| }, | |
| physCellIdCDMA2000 | PhysCellIdCDMA2000 |
| } | |
| -- ASN1STOP. | |

The channel state information (CSI) related radio resource control (RRC) configuration may be defined for the purpose of channel quality and/or channel state measurements. The user equipment (UE) 204 may report the channel state information (CSI) in the physical layer. Depending on the reporting mode, either the cell-specific reference signal (CRS) or the channel state information reference signal (CSI-RS) is used for the channel state information (CSI) measurement. The E-UTRAN may provide the CQI report configuration (CQI-ReportConfig) and the CSI-RS configuration (CSI-RS-Config) applicable for a user equipment (UE) 204 in RRC_CONNECTED using dedicated signaling (i.e., using the radioResourceConfigDedicated in the RRCConnectionReconfiguration message).

The information element (IE) CSI-RS-Config may be used to specify the channel state information (CSI) reference signal configuration. The information element (IE) CSI-RS-Config may include configurations for the number of antenna ports for CSI-RS, the physical resource for CSI-RS, the subframes for CSI-RS, etc. The information element (IE) CQI-ReportConfig may be used to specify the CQI reporting configuration of a user equipment (UE) 204.

Once the user equipment (UE) 204 has generated a measurement report 252, the user equipment (UE) 204 may use the feedback module 251 to transmit the measurement report 252 to the E-UTRAN.

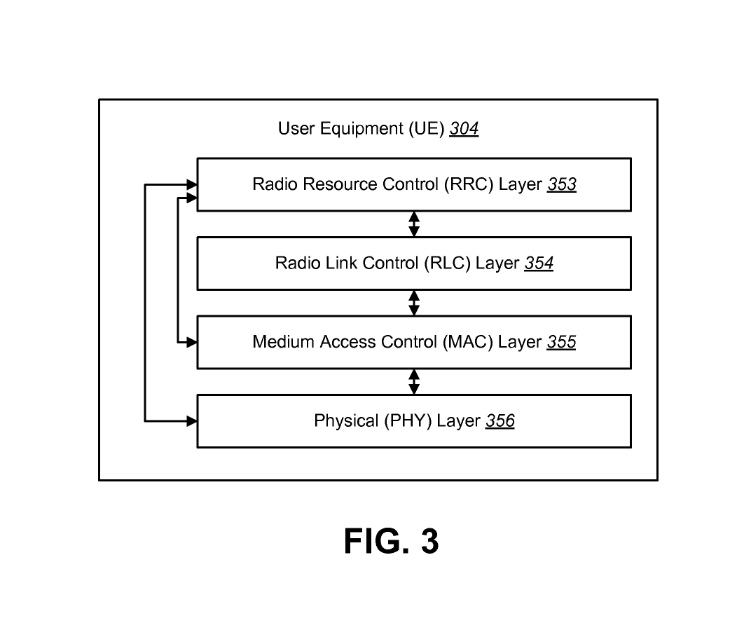

FIG. 3 is a block diagram illustrating the layers used by a user equipment (UE) 304. The user equipment (UE) 304 of FIG. 3 may be one configuration of the user equipment (UE) 104 of FIG. 1. The user equipment (UE) 304 may include a radio resource control (RRC) layer 353, a radio link control (RLC) layer 354, a medium access control (MAC) layer 355 and a physical (PHY) layer 356. From the physical (PHY) layer 356, each of the radio resource control (RRC) layer 353, the radio link control (RLC) layer 354 and the medium access control (MAC) layer 355 may be referred to as higher layers 114. The user equipment (UE) 304 may include additional layers not shown in FIG. 3.

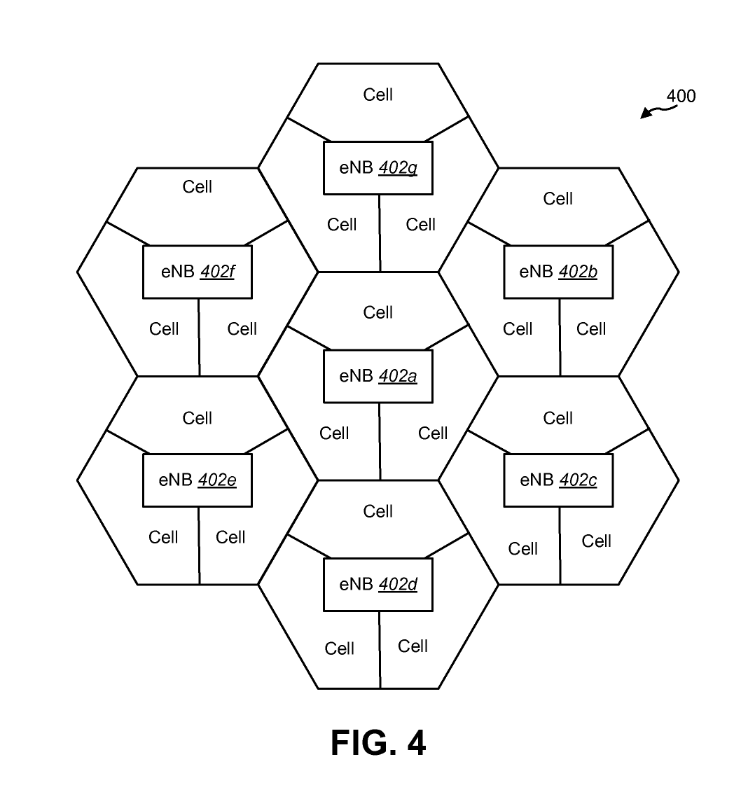

FIG. 4 is a block diagram illustrating a homogenous network 400 with intra-site coordinated multipoint (CoMP). Each eNB 402a-g may operate three cells. Each eNB 402a-g may transmit downlink signals for the three cells. The coordination area for this homogenous network 400 is three cells for each eNB 402.

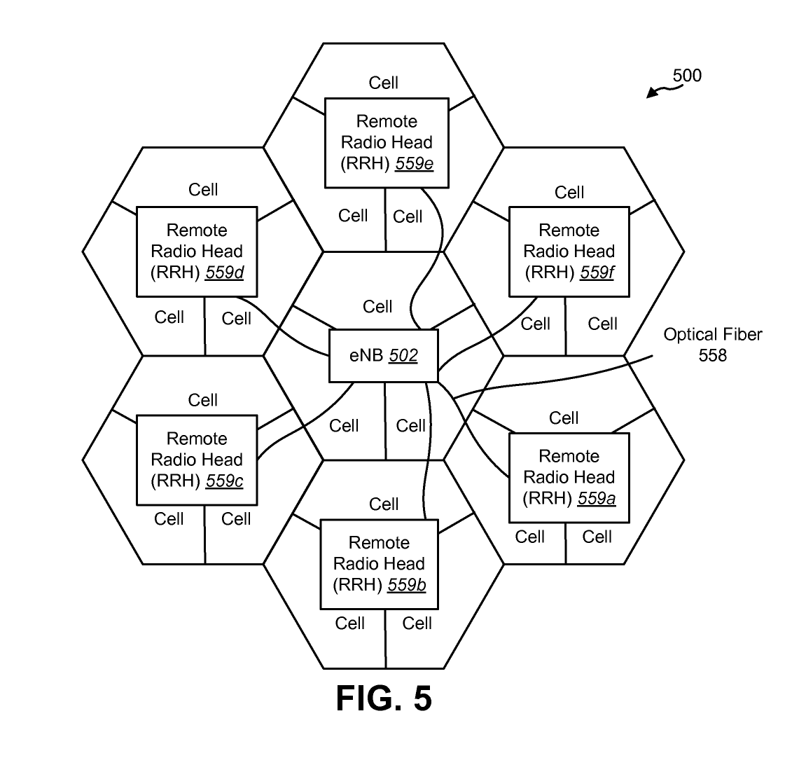

FIG. 5 is a block diagram illustrating a homogenous network 500 with high Tx power remote radio heads (RRHs) 559a-f. Each remote radio head (RRH) 559 and an eNB 502 may also be referred to as a point. The eNB 502 may operate 21 cells using six remote radio heads (RRHs) 559. Each remote radio head (RRH) 559 and the eNB 502 may transmit downlink signals for the three cells associated with the remote radio head (RRH) 559. Each remote radio head (RRH) 559 may be coupled to the eNB 502 via an optical fiber 558. The coordination area for this homogenous network 500 is 21 cells.

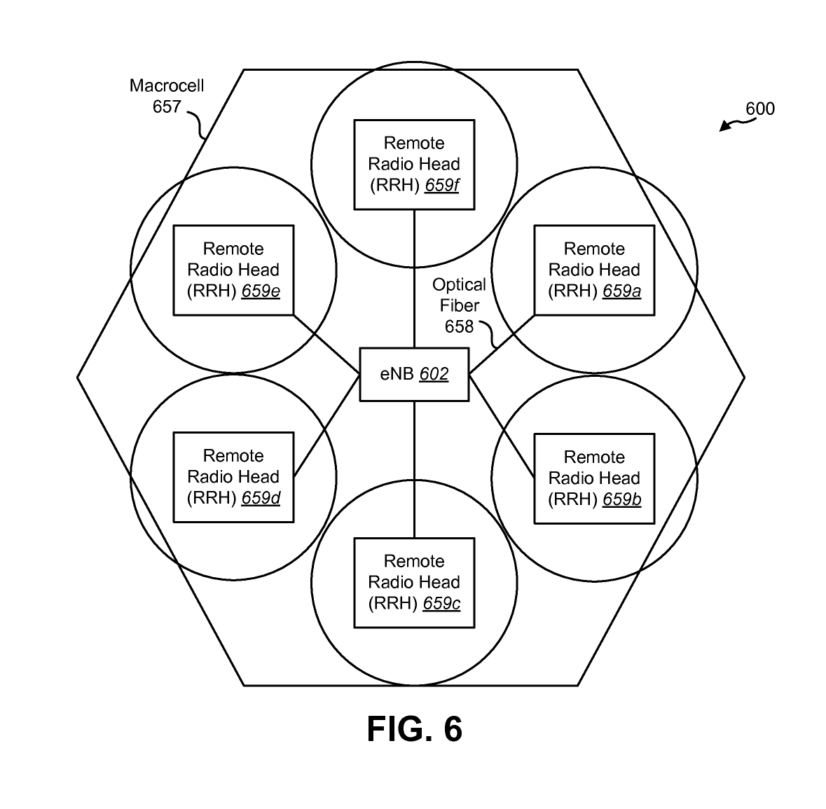

FIG. 6 is a block diagram illustrating a network 600 with low Tx power remote radio heads (RRHs) 659a-f within the macrocell 657 coverage. Each remote radio head (RRH) 659 and an eNB 602 may also be referred to as a point. The macrocell 657 may include an eNB 602 coupled to multiple low Tx power remote radio heads (RRHs) 659 via optical fibers 658. The eNB 602 operates one macrocell 657 and six areas using the six remote radio heads (RRHs) 659. The coordination area for this heterogeneous network is one macrocell 657 and six areas.

The transmission/reception points created by the remote radio heads (RRHs) 659 may have the same cell ID as the macrocell 657 or different cell IDs from the macrocell 657. When the transmission/reception points created by the remote radio head (RRH) 659 have the same cell IDs as the macrocell 657, it is commonly understood that all the transmission points transmit the same cell-specific reference signal (CRS) but can transmit different channel state information reference signals (CSI-RSs).

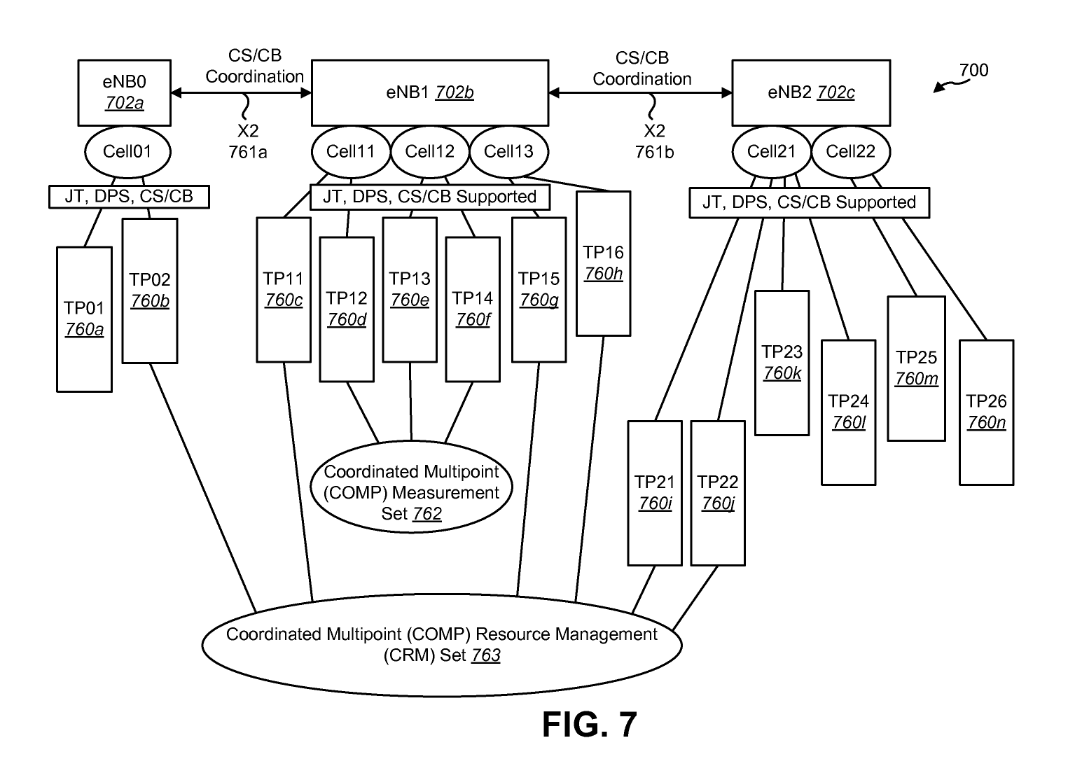

FIG. 7 is a block diagram illustrating a generalized coordinated multipoint (CoMP) architecture 700. Multiple coordinated multipoint (CoMP) measurement sets 762 may be used for user equipment (UE) 104. For example, a coordinated multipoint (CoMP) cooperating set may be a set of geographically separated points directly and/or indirectly participating in data transmission to a user equipment (UE) 104 in a time-frequency resource. The coordinated multipoint (CoMP) cooperating set may or may not be transparent to the user equipment (UE) 104.

The coordinated multipoint (CoMP) transmission points 760a-n may be a point or set of points transmitting data to a user equipment (UE) 104. The coordinated multipoint (CoMP) transmission points 760 are a subset of the coordinated multipoint (CoMP) cooperating set. A coordinated multipoint (CoMP) measurement set 762 may be the set of points about which channel state/statistical information related to their link to the user equipment (UE) 104 is measured and/or reported at L1 (PUCCH or PUSCH). A coordinated multipoint (CoMP) resource management (CRM) set 763 may be the set of cells for which radio resource management (RRM) measurements for the coordinated multipoint (CoMP) are performed. The radio resource management (RRM) measurement for cell-specific reference signal (CRS) is already defined in Rel-8. Additional radio resource management (RRM) measurement methods (such as coordinated multipoint (CoMP) resource management (CRM) measurement) may be considered (e.g., in order to separate different points belonging to the same logical cell entity or in order to select the coordinated multipoint (CoMP) measurement set 762).

In the generalized coordinated multipoint (CoMP) architecture 700, fast coordination coordinated multipoint (CoMP) schemes (e.g., JT, DPS, CS/CB) may be used only for intra-eNB communications while slower coordination coordinated multipoint (CoMP) schemes (e.g., CS/CB) may be used for inter-eNB communications. In Rel-11, only control information may be transmitted over X2 761 a-b; no data may be transported over X2 761. Proprietary inter-eNB interfaces may be used to provide faster schemes for inter-eNB communication (especially in cases of co-located eNBs 702a-c). Since the user equipment (UE) 104 only knows cells (and not eNBs 702), this has no impact on the user equipment (UE) 104.

While the network may be aware of all the coordinated multipoint (CoMP) measurement sets 762, the user equipment (UE) 104 may only know of two coordinated multipoint (CoMP) measurement sets 762: the coordinated multipoint (CoMP) measurement set 762 and the coordinated multipoint (CoMP) resource management (CRM) set 763.

The coordinated multipoint (CoMP) resource management (CRM) measurement may be based on a channel state information reference signal (CSI-RS) measurement. This is because a CRS-based radio resource management (RRM) measurement will not work when the transmission/reception points created by remote radio heads (RRHs) 659 have the same cell ID as the macrocell 657 (as illustrated above in relation to FIG. 6), the transmission points 760 are not distinguishable to the user equipment (UE) 104 using the cell-specific reference signal (CRS). Using the channel state information reference signal (CSI-RS), the reference signal received power (RSRP) and reference signal received quality (RSRQ) may still be measured (referred to as the CSI-RSRP and/or the CSI-RSRQ). The CSI-RSRP and/or the CSI-RSRQ may be used by the network to determine which transmission points 760 should be included in the coordinated multipoint (CoMP) measurement set 762 (e.g., addition, removal, replacement). Inter-cell handover may not be one of the purposes of the coordinated multipoint (CoMP) resource management (CRM) measurement.

The measurement of the CSI-RSRP and/or the CSI-RSRQ needs to be defined. Currently, the channel state information reference signal (CSI-RS) is used for channel state information (CSI) measurement but not for coordinated multipoint (CoMP) radio management (CRM) measurement. Therefore, the CSI-RSRP and/or the CSI-RSRQ measurements may be used for coordinated multipoint (CoMP) radio management (CRM) measurement. The CSI-RSRP and/or the CSI-RSRQ measurements may also be used for mobility purposes.

FIG. 8 is a block diagram illustrating the structure of a measurement configuration variable 864. The measurement configuration variable 864 may be referred to as VarMeasConfig. Both the user equipment (UE) 104 and the eNB 102 may maintain the measurement configuration variable 864. The measurement configuration variable 864 may include a list of measurement IDs 865a-c, a list of measurement objects 866 and a list of report configurations 867. The list of measurement IDs 865 may include one or more measurement IDs 878a-c, one or more measurement object IDs 879a-c and one or more report configuration IDs 880a-c. Each measurement ID 878 may be linked to a measurement object ID 879 and a report configuration ID 880. FIG. 8 shows both measId#1 878a and measId#2 878b link to measObjectId#1 879a as one example.

In Release-10, measurement identity addition and/or modification procedures may be performed during radio resource control (RRC) connection reconfiguration if the RRCConnectionReconfiguration message includes the measConfig and the received measConfig includes the measIdToAddModList. The user equipment (UE) 104 may perform the measurement identity addition and/or modification procedures for each measId 878 included in a received measIdToAddModList. If an entry with the matching measId 878 exists in the measIdList 865 within the VarMeasConfig 864, the user equipment (UE) 104 may replace the entry with the value received for the measId 878. Otherwise, the user equipment (UE) 104 may add a new entry for this measId 878 within the VarMeasConfig 864. The eNB 102 may consider or assume that the addition and/or modification procedure has been done in the user equipment (UE) 104.

In Release-10, measurement object addition and/or modification procedures may be performed during radio resource control (RRC) connection reconfiguration if the RRCConnectionReconfiguration message includes the measConfig and the received measConfig includes the measObjectToAddModList. The user equipment (UE) 104 may perform the measurement object addition and/or modification procedures for each measObjectId 879 included in a received measObjectToAddModList. If an entry with the matching measObjectId 879 exists in the measObjectList 866 within the VarMeasConfig 864, the user equipment (UE) 104 may replace the entry with the value received for the measObjectId 879. Otherwise, the user equipment (UE) 104 may add a new entry for this measObjectId 879 within the VarMeasConfig 864. The eNB 102 may consider or assume that the addition and/or modification procedure has been done in the user equipment (UE) 104.

FIG. 9 is a block diagram illustrating the structure of a measurement report list 968. The measurement report list 968 may be referred to as VarMeasReportList. Both the user equipment (UE) 104 and the eNB 102 may maintain the measurement report list 968. The measurement report list 968 may include multiple measurement reports 969a-c. Each measurement report 969 may include the measurement ID 978a-c and the list of cells that triggered the measurement report 969. For coordinated multipoint (CoMP) resource management (CRM) measurement, each measurement report 969 may include the measurement ID 978a-c and the list of CSI-RSs that triggered the measurement report 969.

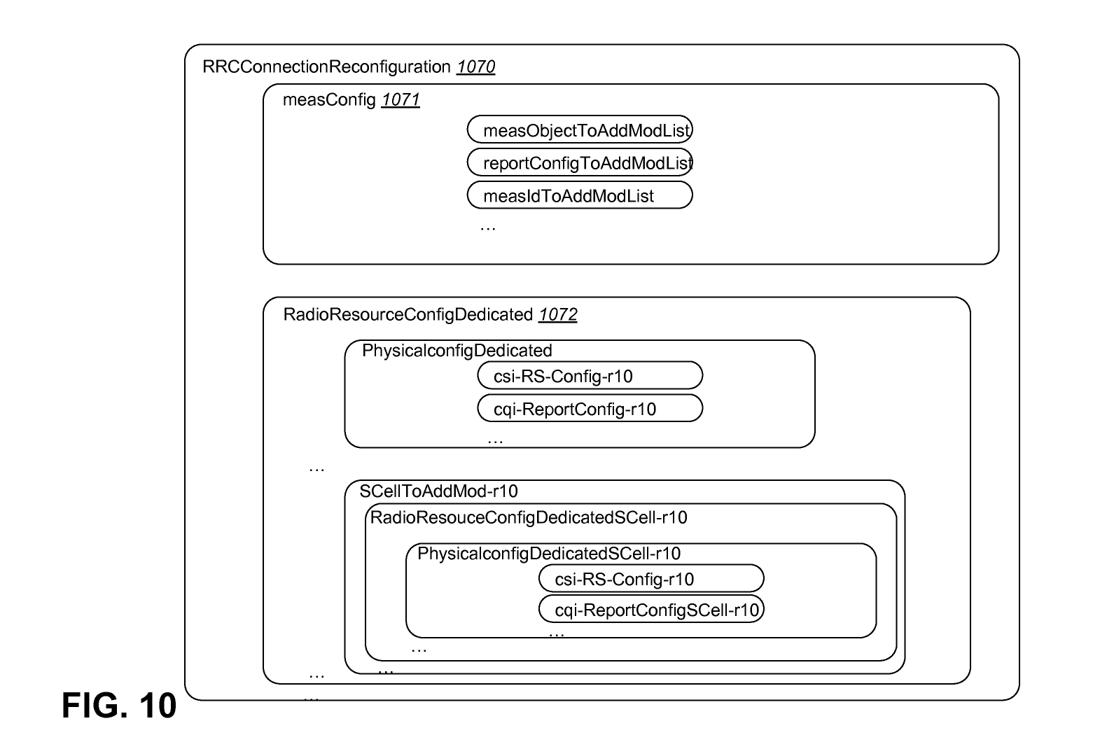

FIG. 10 is a block diagram illustrating an RRC Connection Reconfiguration message 1070 structure. The RRC Connection Reconfiguration message 1070 may be referred to as RRCConnection Reconfiguration. The RRC Connection Reconfiguration message 1070 may include measurement configurations 1071 and the radio resources dedicated 1072.

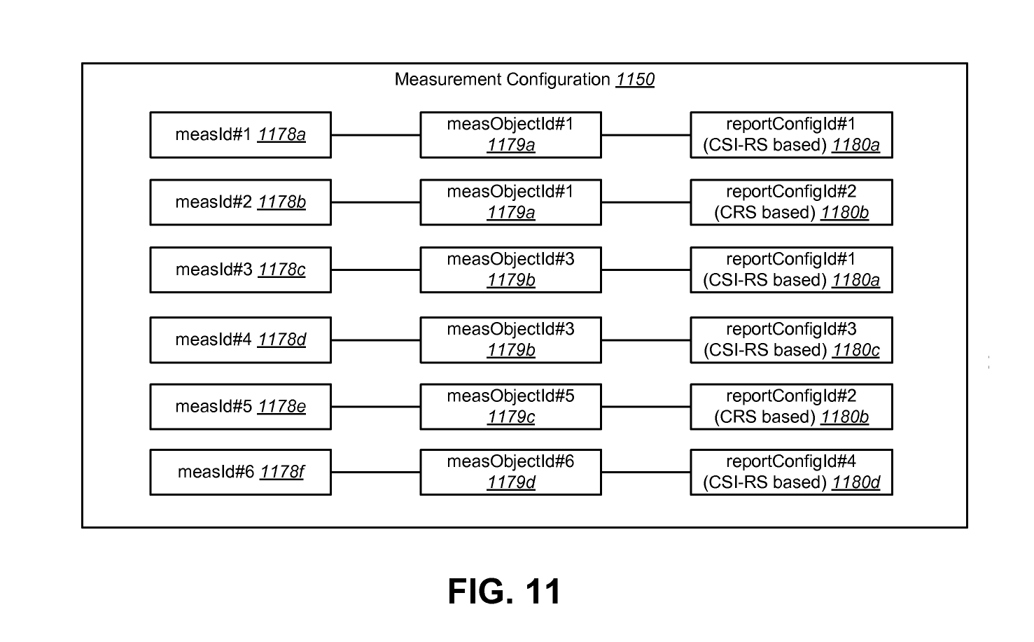

FIG. 11 is a block diagram of a measurement configuration 1150 that includes measurement identifications, measurement objects and report configurations. The measurement configuration 1150 is one example of a measurement configuration 1150 that may be transmitted from an eNB 102 to a user equipment (UE) 104. The measurement configuration 1150 may include one or more measurement identifications (measIds) 1178a-f. In one configuration, the measurement configuration 1150 may instruct the user equipment (UE) 104 to change settings. For example, the measurement configuration 1150 may instruct the user equipment (UE) 104 to add, modify or remove a measId 1178 from the measurement configurations of the user equipment (UE) 104.

Each measId 1178a-f may be linked to either cell-specific reference signal (CRS) or channel state information reference signal (CSI-RS). In Rel-10, a measId 1178 may only be linked to cell-specific reference signal (CRS) based radio resource management (RRM) measurements. When a measId 1178 is signaled, the measId 1178 may be associated with a measObjectId 1179a-d and a reportConfigld 1180a-d.

When sets of CSI-RS configurations are included in a measurement object configuration or a physical configuration, the measObject does not specify whether it is for cell-specific reference signal (CRS) or channel state information reference signal (CSI-RS). Therefore, each reportConfig may include an indication of whether the reportConfig is for cell-specific reference signal (CRS) or channel state information reference signal (CSI-RS). The indication in the reportConfig may be one or more new event identities (e.g., events C1 and C2) with a different identify other than cell-specific reference signal (CRS) based events. An event identity may identify measurement reporting events (i.e., the current list of events A1-A6 discussed above in relation to FIG. 2). Events A1-A6 are defined as events based on measurement results of the cell-specific reference signal (CRS) of the serving cell and/or the neighbor cell. In addition, events based on the measurement results of the channel state information reference signals (CSI-RSs) (of the serving cell and/or the neighbor cell) and/or the cell-specific reference signal (CRS) (of the serving cell and/or the neighbor cell) may be used.

The indication may instead be an explicit indication {CRS, CSI-RS}. The explicit indication may be {CRS, CSI-RS, both}, where “both” means both the cell-specific reference signal (CRS) and the channel state information reference signal (CSI-RS). The explicit indication may be add-CSI-RS-report {setup} to indicate whether the measurement report should include the measurement results of CSI-RS(s). When a measurement ID (measId) 1178 is signaled, a measurement object identity (measObjectId) 1179 and a report configuration identity (reportConfigld) 1180 are associated with the measId 1178. Therefore, the report configuration can define whether the measId 1178 is for channel state information reference signal (CSI-RS) based radio resource management (RRM) measurement or cell-specific reference signal (CRS) based radio resource management (RRM) measurement. An explicit or implicit indication may also be used in configurations where sets of CSI-RS configurations are included in a measurement object configuration.

In Release-10, a measurement identity addition/modification procedure may be performed during a radio resource control (RRC) connection reconfiguration procedure. Specifically, an addition/modification procedure may be performed during radio resource control (RRC) connection reconfiguration if the RRCConnection Reconfiguration message 1070 includes the measurement configuration 1150 and the received measurement configuration 1150 includes the measIdToAddModList.

In Release-10, an action related to measurements on a handover, a re-establishment and/or an SCell release is not defined for coordinated multipoint (CoMP) resource management (CRM) measurement. Having actions related to coordinated multipoint (CoMP) resource management (CRM) measurement on handover, reestablishment, SCell release and other actions may provide more efficient measurement and configuration.

Efficient updating and measurement may be achieved for a user equipment (UE) 104 by performing a measurement identity autonomous removal for channel state information reference signal (CSI-RS) based measurement in a serving cell (i.e., an SCell 107b) when the serving cell is released. Further, efficient updating and measurement may be accomplished on a user equipment (UE) 104 by removing channel state information reference signal (CSI-RS) based measurement identities (measId) related to the source primary cell (i.e., PCell 107a) when the user equipment (UE) 104 performed inter-cell handover or re-establishment.

Further, efficient updating and measurement may be achieved for a user equipment (UE) 104 by performing a measurement object autonomous removal or autonomous modification for channel state information reference signal (CSI-RS) based measurement in a serving cell (i.e., an SCell 107b) when the serving cell is released. Also, efficient updating and measurement may be accomplished on a user equipment (UE) 104 by removing or modifying a measurement object for channel state information reference signal (CSI-RS) to the source primary cell (i.e., PCell 107a) when the user equipment (UE) 104 performed handover or re-establishment.

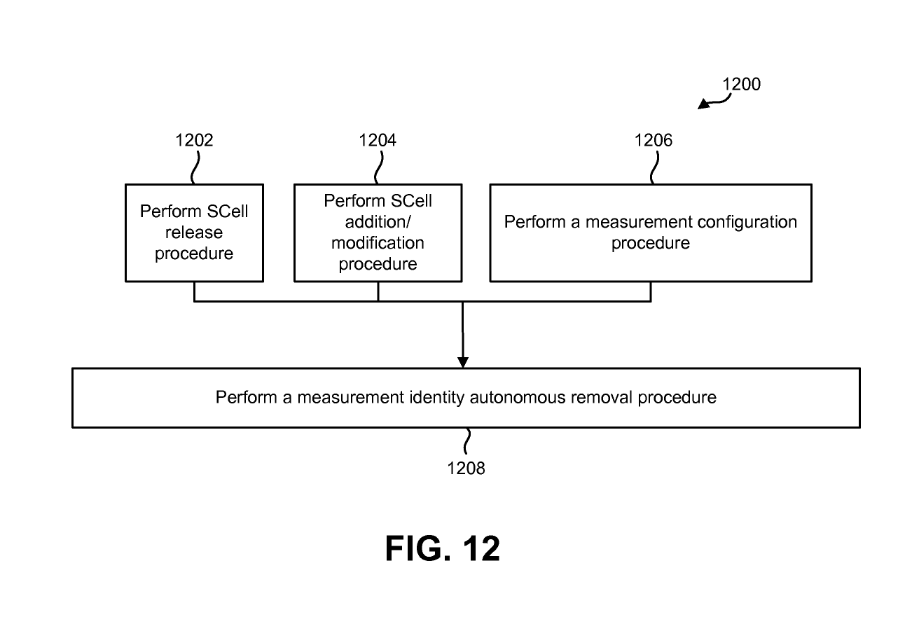

FIG. 12 is a flow diagram of a method 1200 for measurement identity autonomous removal related to coordinated multipoint (CoMP) resource management (CRM) measurements. The method 1200 may be performed by a user equipment (UE) 104. The eNB 102 may consider/assume that the user equipment (UE) 104 has performed the method 1200.

The method 1200 may be performed during a radio resource control (RRC) connection reconfiguration procedure or during a radio resource control (RRC) connection re-establishment procedure. In one configuration, the method 1200 may be performed after the user equipment (UE) 104 has performed 1202 an SCell release procedure during a radio resource control (RRC) connection reconfiguration procedure. In another configuration, the method 1200 may be performed after the user equipment (UE) 104 has performed 1202 an SCell release procedure during a radio resource control (RRC) connection re-establishment procedure.

In another configuration, the method 1200 may be performed after the user equipment (UE) 104 has performed 1204 an SCell addition/modification procedure during a radio resource control (RRC) connection reconfiguration procedure. The method 1200 may also be performed after the user equipment (UE) 104 has performed 1204 an SCell addition/modification procedure during a radio resource control (RRC) connection re-establishment procedure. The method 1200 may further be performed after the user equipment (UE) 104 has performed 1206 a measurement configuration procedure during a radio resource control (RRC) connection reconfiguration procedure. The method 1200 may also be performed after the user equipment (UE) 104 has performed 1206 a measurement configuration procedure during a radio resource control (RRC) connection re-establishment procedure.

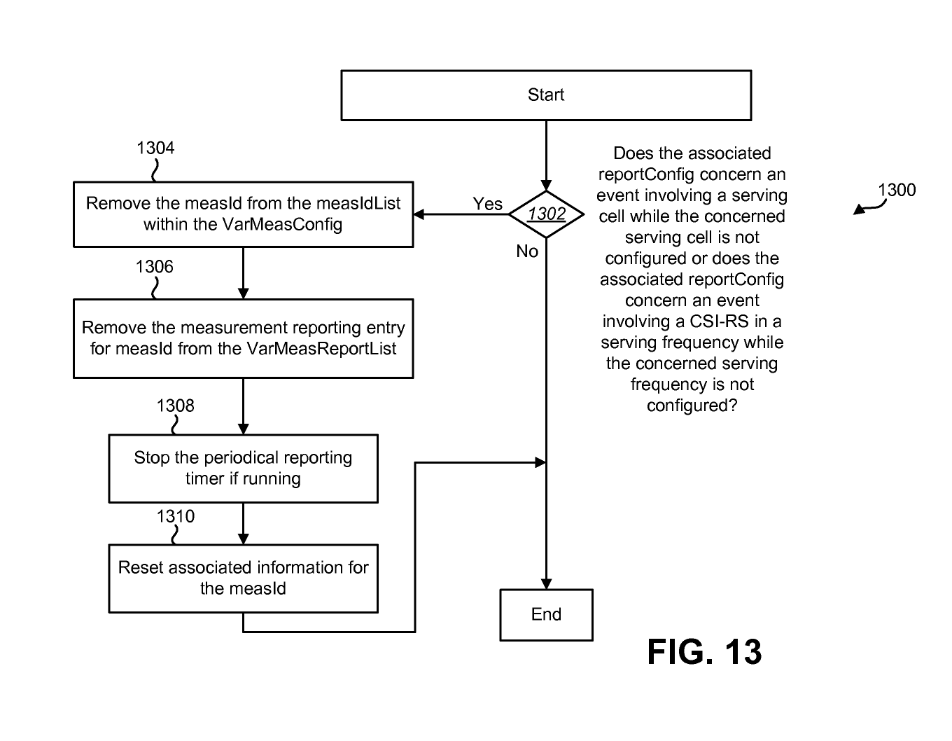

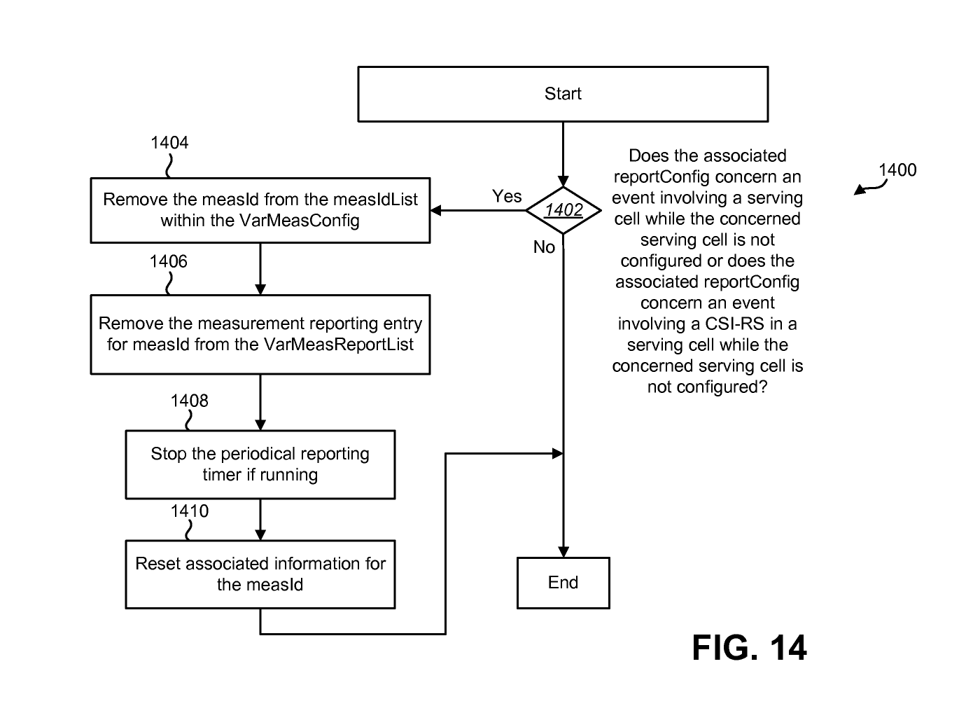

After any of these procedures, the user equipment (UE) 104 may perform 1208 a measurement identity autonomous removal procedure. The measurement identity autonomous removal procedure may be performed 1208 for each measId 878 included in a measIdList 865 within a VarMeasConfig 864. A measurement identity autonomous removal procedure is described in more detail below in relation to FIGS. 13-14.

FIG. 13 is a flow diagram of a method 1300 for measurement identity autonomous removal. The method 1300 may be performed by a user equipment (UE) 104. The eNB 102 may consider/assume that the user equipment (UE) 104 has performed the method 1300. FIG. 13 illustrates one method 1300 for performing 1208 the measurement identity autonomous removal procedure of FIG. 12. The method 1300 may be performed for each measId 878 included in a measIdList 865 within a VarMeasConfig 864.

The user equipment (UE) 104 may determine 1302 whether an associated reportConfig concerns an event involving a serving cell while the concerned serving cell is not configured and may also determine 1302 whether the associated reportConfig concerns an event involving a channel state information reference signal (CSI-RS) in a serving frequency while the concerned serving frequency is not configured. If the associated reportConfig concerns an event involving a serving cell while the concerned serving cell is not configured or if the associated reportConfig concerns an event involving a channel state information reference signal (CSI-RS) in a serving frequency while the concerned serving frequency is not configured, the user equipment (UE) 104 may remove 1304 the measId 878 from the measIdList 865 within VarMeasConfig 864. The user equipment (UE) 104 may proceed to remove 1306 the measurement reporting entry for the measId 878 from the VarMeasReportList 968, if included. The user equipment (UE) may then stop 1308 the periodical reporting timer, if running, and reset 1310 the associated information (e.g., timeToTrigger) for the measId 878. The method 1300 may then end.

If the associated reportConfig does not concern an event involving a serving cell while the concerned serving cell is not configured and if the associated reportConfig does not concern an event involving a channel state information reference signal (CSI-RS) in a serving frequency while the concerned serving frequency is not configured, the method 1300 may end. As discussed above, the measurement identity autonomous removal procedure (i.e., the method 1300) may be performed for each measId 878 included in the measIdList 865 within a VarMeasConfig.

The measurement identity autonomous removal (e.g., step 1304) may apply for different measurement events. For example, the measurement identity autonomous removal may apply for measurement events A1, A2 and A6 described above in connection with FIG. 2. The measurement identity autonomous removal procedure may also apply for measurement event C (e.g., C1, C2), where measurement event C is a trigger event specific to channel state information reference signal (CSI-RS) based measurements. Namely, an event involving a serving cell may be measurement events A1, A2 and A6. An event involving a channel state information reference signal (CSI-RS) in a serving frequency may be measurement event C1 and C2. Further, when the measurement identity autonomous removal procedure is performed during re-establishment, the user equipment (UE) 104 may only be configured with a primary frequency (i.e., the SCells(s) are released, if configured).

When the serving frequency is de-configured to SCell release, channel state information reference signal (CSI-RS) based measurements (i.e., measurement identities (measId)) concerning the serving frequency may be removed. Namely, the user equipment (UE) 104 may perform measurement identity autonomous removal for a channel state information reference signal (CSI-RS) based measurement concerning a CSI-RS in a serving frequency when the serving frequency is released. An event involving a serving cell is different than an event involving a channel state information reference signal (CSI-RS) in a serving frequency of a serving cell because an event involving a serving cell represents cell-specific reference signal (CRS) based measurements rather than channel state information reference signal (CSI-RS) based measurements. A channel state information reference signal (CSI-RS) resource may be configured for a serving cell or alternatively for a serving frequency of a serving cell. In performing channel state information reference signal (CSI-RS) based measurements, the measurements may not relate specifically to the serving cell, but rather to the configured channel state information reference signal (CSI-RS) in a serving frequency.

FIG. 14 is a flow diagram of another method 1400 for measurement identity autonomous removal. The method 1400 may be performed by a user equipment (UE) 104. The eNB 102 may consider/assume that the user equipment (UE) 104 has performed the method 1400. FIG. 14 illustrates one method 1400 for performing 1208 a measurement identity autonomous removal procedure of FIG. 12. The method 1400 may be performed for each measId 878 included in a measIdList 865 within a VarMeasConfig 864.

The user equipment (UE) 104 may determine 1402 whether an associated reportConfig concerns an event involving a serving cell while the concerned serving cell is not configured and may also determine 1402 whether an associated reportConfig concerns an event involving a channel state information reference signal (CSI-RS) in a serving cell while the concerned serving cell is not configured. If the associated reportConfig concerns an event involving a serving cell while the concerned serving cell is not configured or if the associated reportConfig concerns an event involving a channel state information reference signal (CSI-RS) in a serving cell while the concerned serving cell is not configured, the user equipment (UE) 104 may remove 1404 the measId 878 from the measIdList 865 within VarMeasConfig 864. The user equipment (UE) 104 may proceed to remove 1406 the measurement reporting entry for the measId 878 from the VarMeasReportList 968, if included. The user equipment (UE) may then stop 1408 the periodical reporting timer, if running, and reset 1410 the associated information (e.g., timeToTrigger) for the measId 878. The method 1400 may then end.

If the associated reportConfig does not concern an event involving a serving cell while the concerned serving cell is not configured and if the associated reportConfig does not concern an event involving a channel state information reference signal (CSI-RS) in a serving cell while the concerned serving cell is not configured, the method 1400 may end. As discussed above, the measurement identity autonomous removal procedure (i.e., the method 1400) may be performed for each measId 878 included in the measIdList 865 within a VarMeasConfig.

The measurement identity autonomous removal (e.g., step 1404) described in connection with FIG. 14 may apply for different measurement events. For example, the measurement identity autonomous removal may apply for measurement events A1, A2 and A6 described above in connection with FIG. 2. The measurement identity autonomous removal procedure may also apply for measurement event C (e.g., C1, C2), where measurement event C is a trigger event specific to channel state information reference signal (CSI-RS) based measurements. Namely, an event involving a serving cell may be measurement events A1, A2 and A6. An event involving a channel state information reference signal (CSI-RS) in a serving frequency may be measurement event C1 and C2. Further, when the measurement identity autonomous removal procedure is performed during re-establishment, the user equipment (UE) 104 may only be configured with a primary frequency (i.e., the SCells(s) are released, if configured).

When the serving cell is de-configured to SCell release, channel state information reference signal (CSI-RS) based measurements (i.e., measurement identities) concerning the serving cell may be removed. Namely, the user equipment (UE) 104 may perform measurement identity autonomous removal for a channel state information reference signal (CSI-RS) based measurement concerning a CSI-RS in a serving cell when the serving cell is released. An event involving a serving cell is different than an event involving a channel state information reference signal (CSI-RS) in a serving cell because an event involving a serving cell represents cell-specific reference signal (CRS) based measurements rather than channel state information reference signal (CSI-RS) based measurements.

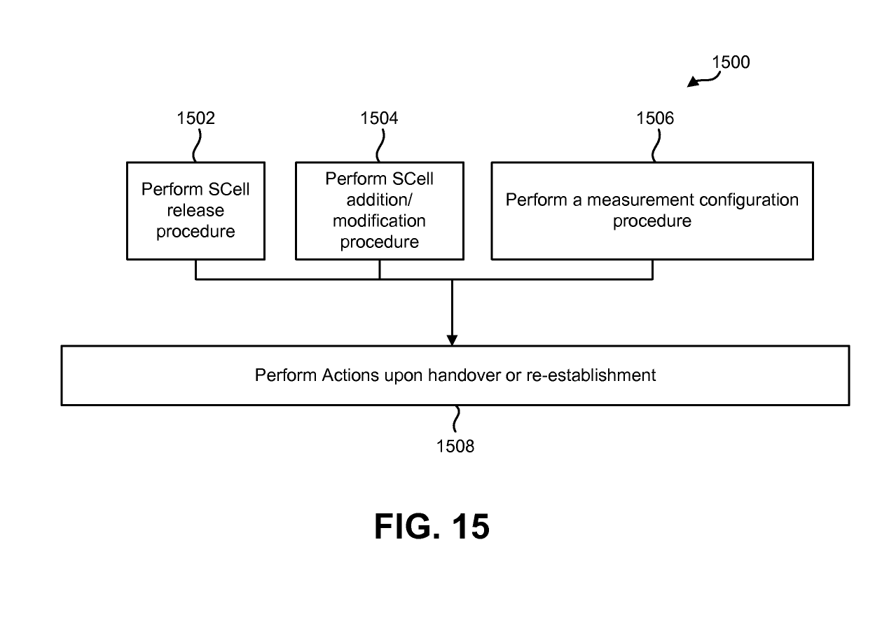

FIG. 15 is a flow diagram of a method 1500 related to actions performed upon handover or re-establishment. The method 1500 may be performed by a user equipment (UE) 104. The eNB 102 may consider/assume that the user equipment (UE) 104 has performed the method 1500. The method 1500 may be performed during a radio resource control (RRC) connection reconfiguration procedure including the mobilityControlInfo (i.e., handover) or during a radio resource control (RRC) connection re-establishment procedure.

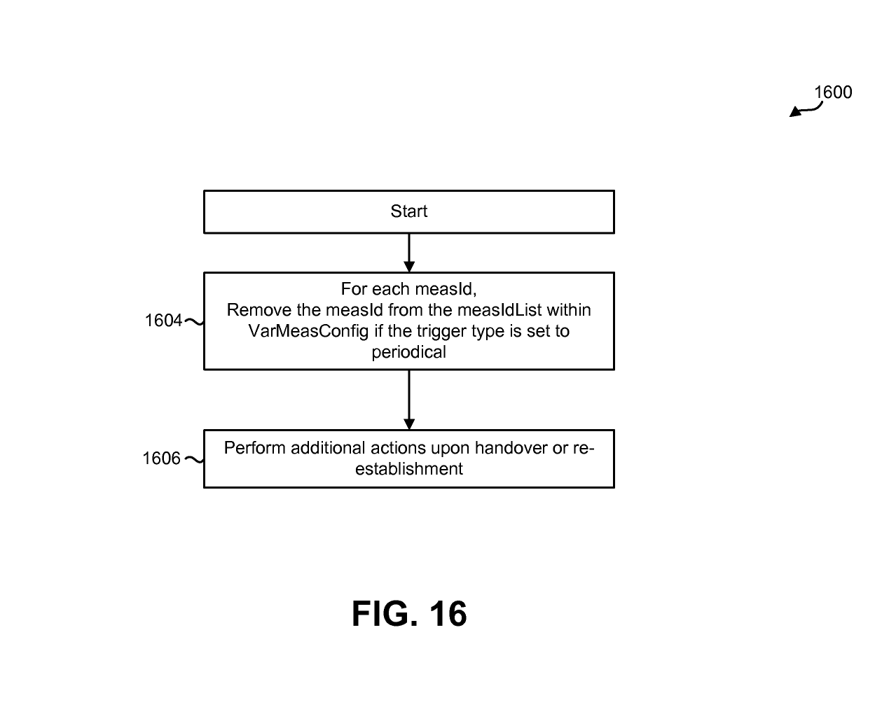

In one configuration, the method 1500 may be performed after the user equipment (UE) 104 has performed 1502 an SCell release procedure during a radio resource control (RRC) connection reconfiguration procedure that includes the mobilityControlInfo (handover). In another configuration, the method 1500 may be performed after the user equipment (UE) 104 has performed 1502 an SCell release procedure during a radio resource control (RRC) connection re-establishment procedure. In yet another configuration, the method 1500 may be performed after the user equipment (UE) 104 has performed 1504 an SCell addition/modification procedure during a radio resource control (RRC) connection reconfiguration procedure that includes the mobilityControlInfo (handover). The method 1500 may also be performed after the user equipment (UE) 104 has performed 1504 an SCell addition/modification procedure during a radio resource control (RRC) connection re-establishment procedure. The method 1500 may further be performed after the user equipment (UE) 104 has performed 1506 a measurement configuration procedure during a procedure for radio resource control (RRC) connection reconfiguration that includes the mobilityControlInfo (handover). The method 1500 may further be performed after the user equipment (UE) 104 has performed 1506 a measurement configuration procedure during a radio resource control (RRC) connection re-establishment procedure. After any of these procedures, the user equipment (UE) 104 may perform 1508 actions upon handover or re-establishment. Performing 1508 actions upon handover or re-establishment is described in additional detail below in relation to FIGS. 16-22.

FIG. 16 is a flow diagram of a method 1600 for performing actions upon handover or re-establishment. The method 1600 may correspond to performing 1508 actions upon handover or re-establishment of FIG. 15. The method 1600 may be performed by a user equipment (UE) 104. The eNB 102 may consider/assume that the user equipment (UE) 104 has performed the method 1600.

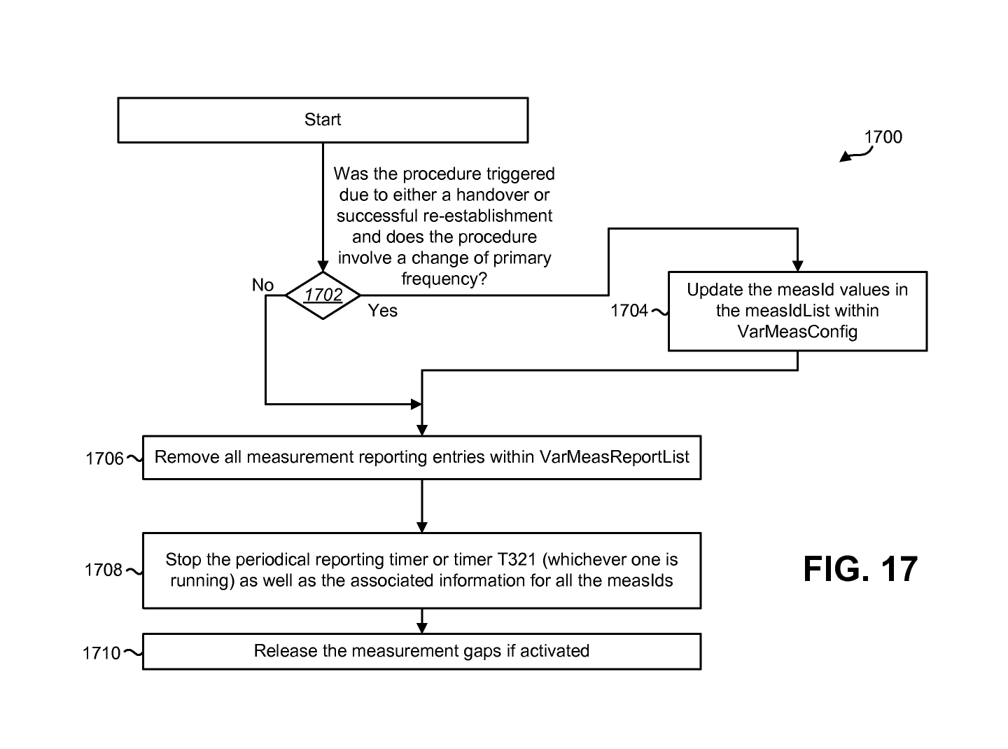

The method 1600 may begin. For each measId 878, the user equipment (UE) 104 may remove 1604 the measId from the measIdList 865 within VarMeasConfig 864 if the trigger type is set to periodical. The user equipment (UE) 104 may then perform 1606 additional actions upon handover or re-establishment. Performing 1606 additional actions upon handover or re-establishment is discussed below in relation to FIG. 17.

FIG. 17 is a flow diagram of another method 1700 for performing actions upon handover or re-establishment. The method 1700 may correspond to performing 1606 additional actions upon handover or re-establishment of FIG. 16. The method 1700 may be performed by a user equipment (UE) 104. The eNB 102 may consider/assume that the user equipment (UE) 104 has performed the method 1700.

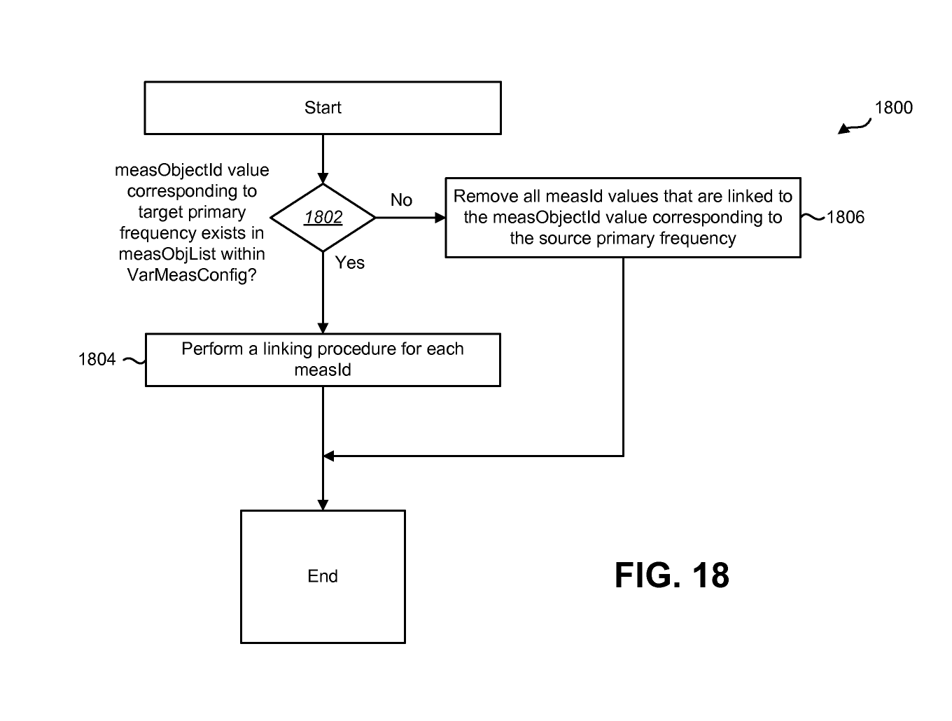

The method 1700 may begin. The user equipment (UE) 104 may determine 1702 whether the procedure (i.e., the method 1700) was triggered due to either a handover or a successful re-establishment and the procedure involves a change of primary frequency. If the procedure was triggered due to either a handover or a successful re-establishment and the procedure involves a change of primary frequency, the user equipment (UE) 104 may update 1704 the measId 878 values in the measIdList 865 within VarMeasConfig 864. Updating 1704 the measId 78 values in the measIdList 865 within VarMeasConfig 864 is discussed in additional detail below in relation to FIG. 18. The user equipment (UE) 104 may then remove 1706 all measurement reporting entries within VarMeasReportList 968.

If the procedure was not triggered due to either a handover or a successful re-establishment procedure and/or the procedure does not involve a change of primary frequency, the user equipment (UE) 104 may remove 1706 all measurement reporting entries within VarMeasReportList 968.

Once the user equipment (UE) has removed 1706 all measurement reporting entries within VarMeasReportList 968, the user equipment (UE) 104 may stop 1708 the periodical reporting timer or timer T321 (whichever one is running) as well as the associated information (e.g., timeToTrigger) for all the measIds 878. The user equipment (UE) 104 may also release 1710 the measurement gaps, if activated.

FIG. 18 is a flow diagram of a method 1800 for updating the measId 878 values in the measIdList 865 within the VarMeasConfig 864. The method 1800 may be performed by a user equipment (UE) 104. The method 1800 may be performed with regard to each measId 878 within a VarMeasConfig 864. The method 1800 of FIG. 18 may correspond to updating 1704 the measId 878 values in the measIdList 865 within VarMeasConfig 864 of FIG. 17.

The method 1800 may start. The user equipment (UE) 104 may determine 1802 whether a measObjectId value corresponding to the target primary frequency exists in measObjList within VarMeasConfig 864. If a measObjectId value corresponding to the target primary frequency does exist in measObjList within VarMeasConfig 864, the user equipment (UE) 104 may perform 1804 a linking procedure for each measId 878 and the method 1800 may end. Otherwise, the user equipment (UE) 104 may remove 1806 all measId 878 linked to the measObjectId value corresponding to the source primary frequency and the method 1800 may end.

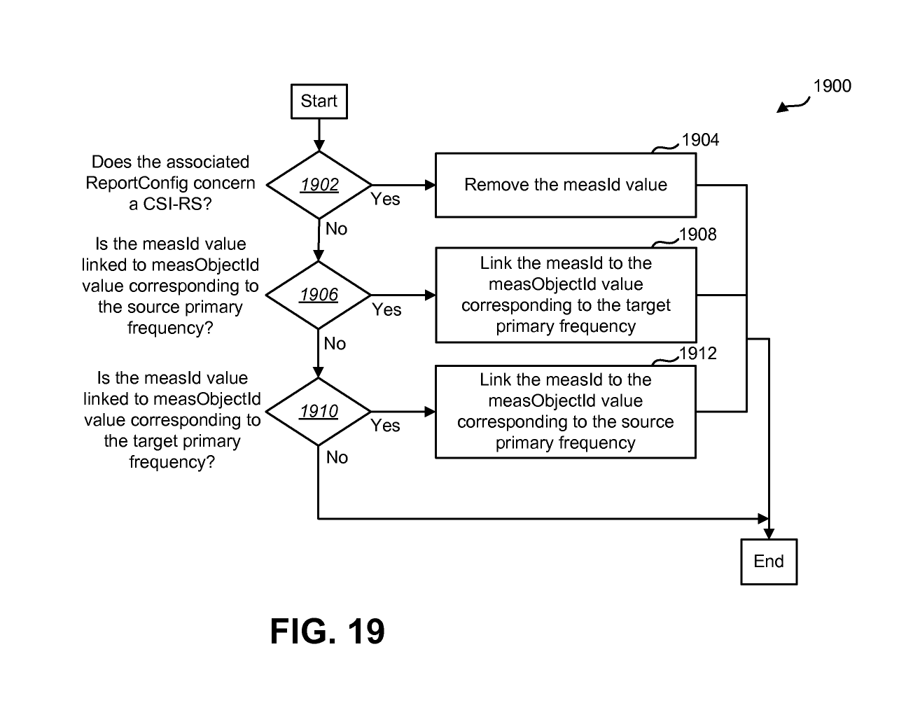

FIG. 19 is a flow diagram of a method 1900 for performing a linking procedure. The method 1900 may correspond to performing 1804 a linking procedure of FIG. 18. The method 1900 may be performed by a user equipment (UE) 104. The eNB 102 may consider/assume that the user equipment (UE) 104 has performed the method 1900. The method 1900 may be performed for each measId 878 included in a measIdList 865 within a VarMeasConfig 864.

The user equipment (UE) 104 may determine 1902 whether the ReportConfig associated with the measId 878 concerns a CSI-RS. If the associated ReportConfig concerns a CSI-RS, the user equipment (UE) 104 may remove 1904 the measId 878 value and the method 1900 may end. If the associated ReportConfig does not concern a CSI-RS, the user equipment (UE) 104 may determine 1906 whether the measId 878 value is linked to the measObjectId value corresponding to the source primary frequency. If the measId 878 value is linked to the measObjectId value corresponding to the source primary frequency, the user equipment (UE) 104 may link 1908 the measId 878 value to the measObjectId value corresponding to the target primary frequency and the method 1900 may end.

If the measId 878 value is not linked to the measObjectId value corresponding to the source primary frequency, the user equipment (UE) 104 may determine 1910 whether the measId 878 value is linked to the measObjectId value corresponding to the target primary frequency. If the measId 878 value is linked to the measObjectId value corresponding to the target primary frequency, the user equipment (UE) 104 may link 1912 the measId 878 value to the measObjectId value corresponding to the source primary frequency and the method 1900 may end. If the measId 878 value is not linked to the measObjectId value corresponding to the target frequency, the method 1900 may end.

As an example, the methods 1500, 1600, 1700, 1800 and 1900 may be used for actions upon handover or re-establishment. In this example, when the user equipment (UE) 104 performs inter-frequency handover or inter-frequency re-establishment (i.e., change of primary frequency), a channel state information reference signal (CSI-RS) measurement (i.e., measurement identity) related to the source primary frequency may be removed. When the user equipment (UE) 104 performs intra-frequency handover or intra-frequency re-establishment (i.e., no change of primary frequency), a channel state information reference signal (CSI-RS) based measurement related to the source primary frequency may be kept. Using channel state information reference signal (CSI-RS) measurement while performing inter-frequency or intra-frequency handover or re-establishment may improve the efficiency of updating measurement identities while performing these procedures.

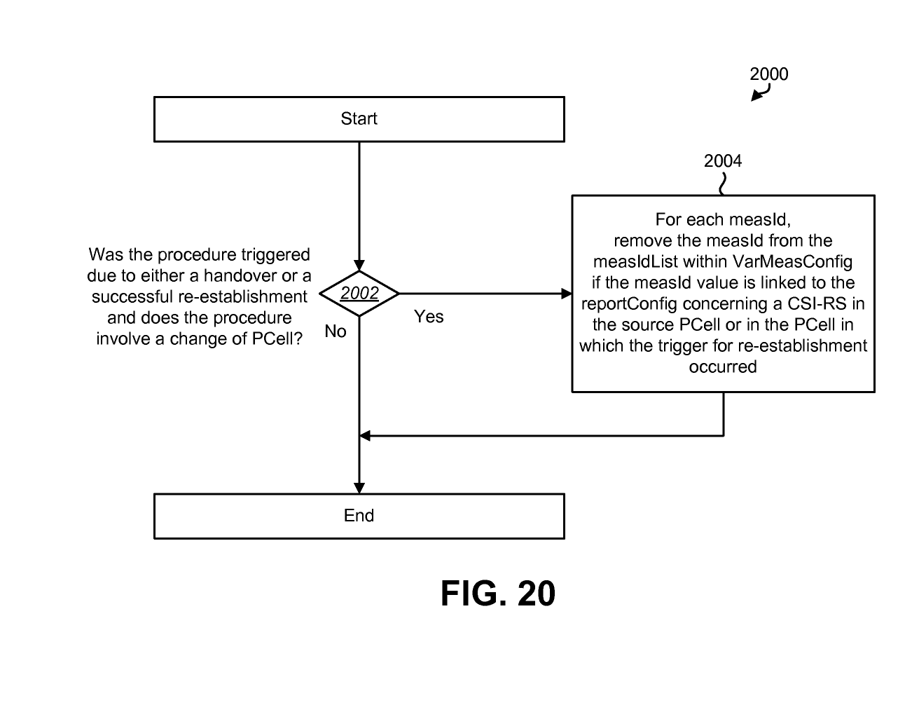

FIG. 20 is a flow diagram of yet another method 2000 for performing actions upon handover or re-establishment. The method 2000 may correspond to performing 1606 additional actions upon handover or re-establishment of FIG. 16. The method 2000 may be performed by a user equipment (UE) 104. The eNB 102 may consider/assume that the user equipment (UE) 104 has performed the method 2000.

The method 2000 may start. The user equipment (UE) 104 may determine 2002 whether the procedure (i.e., the method 2000) was triggered due to either a handover or a successful re-establishment and whether the procedure involves a change of PCell 107a. If the procedure was triggered due to either a handover or a successful re-establishment and the procedure involves a change of PCell 107a, the user equipment (UE) 104 may remove 2004 each measId 878 from the measIdList 865 within a VarMeasConfig 864 if the measId 878 value is linked to the reportConfig concerning a CSI-RS in the source PCell 107a (e.g., handover failure or mobility from E-UTRA failure) or in the PCell 107a in which the trigger for re-establishment occurred. The method 2000 may then end. If the procedure wasn't triggered due to either a handover or a successful re-establishment or the procedure doesn't involve a change of PCell 107a, the method 2000 may end. Once the method 2000 has ended, the method 1700 of FIG. 17 may be performed. Thus, the method 2000 is an additional procedure that may be performed before the method 1700 of FIG. 17.

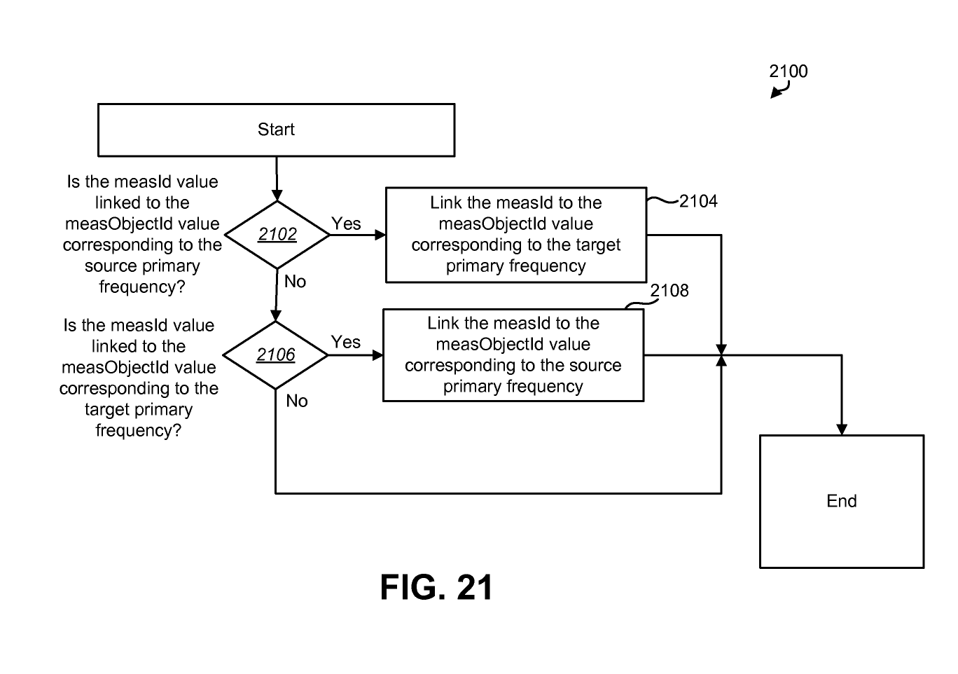

FIG. 21 is a flow diagram of another method 2100 for performing a linking procedure. The method 2100 may correspond to performing 1804 a linking procedure of FIG. 18. The method 2100 may be performed by a user equipment (UE) 104. The eNB 102 may consider/assume that the user equipment (UE) 104 has performed the method 2100. The method 2100 may be performed for each measId 878 included in a measIdList 865 within a VarMeasConfig 864.

The user equipment (UE) 104 may determine 2102 whether the measId 878 value is linked to the measObjectId value corresponding to the source primary frequency. If the measId 878 value is linked to the measObjectId value corresponding to the source primary frequency, the user equipment (UE) 104 may link 2104 the measId 878 value to the measObjectId value corresponding to the target primary frequency and the method 2100 may end.

If the measId 878 value is not linked to the measObjectId value corresponding to the source primary frequency, the user equipment (UE) 104 may determine 2106 whether the measId 878 value is linked to the measObjectId value corresponding to the target primary frequency. If the measId 878 value is linked to the measObjectId value corresponding to the target primary frequency, the user equipment (UE) 104 may link 2108 the measId 878 value to the measObjectId value corresponding to the source primary frequency and the method 1900 may end. If the measId 878 value is not linked to the measObjectId value corresponding to the target frequency, the method 1900 may end.

As an example, the methods 1500, 1600, 2000, 1700, 1800 and 2100 may be used for actions upon handover or re-establishment. In this example, when the user equipment (UE) 104 performs inter-cell handover or inter-cell re-establishment (e.g., a change of PCell 107a), the channel state information reference signal (CSI-RS) based measurement (i.e., measurement identity) related to the source PCell 107a may be removed. Inter-cell handover may be any normal handover operation except for intra-cell handover (e.g., handover used for security updates for a cell). The inter-cell re-establishment operation may include cases that a user equipment (UE) 104 returns to another cell than the source PCell 107a in cases of inter-cell handover failure or mobility from E-UTRAN failure. The intra-cell re-establishment may include cases that the user equipment (UE) 104 returns to the PCell 107a in which the trigger for re-establishment occurred due to detecting radio link failure, integrity check failure from lower layers or a radio resource control (RRC) connection reconfiguration procedure failure. In some configurations, when a user equipment (UE) 104 performs intra-cell handover or intra-cell reconfiguration with no change of the PCell 107a, channel state information reference signal (CSI-RS) based measurements related to the source PCell 107a may be kept. Keeping the channel state information reference signal (CSI-RS) based measurements during intra-cell handover or intra-cell reconfiguration may result in more efficient updates of measurement identities.

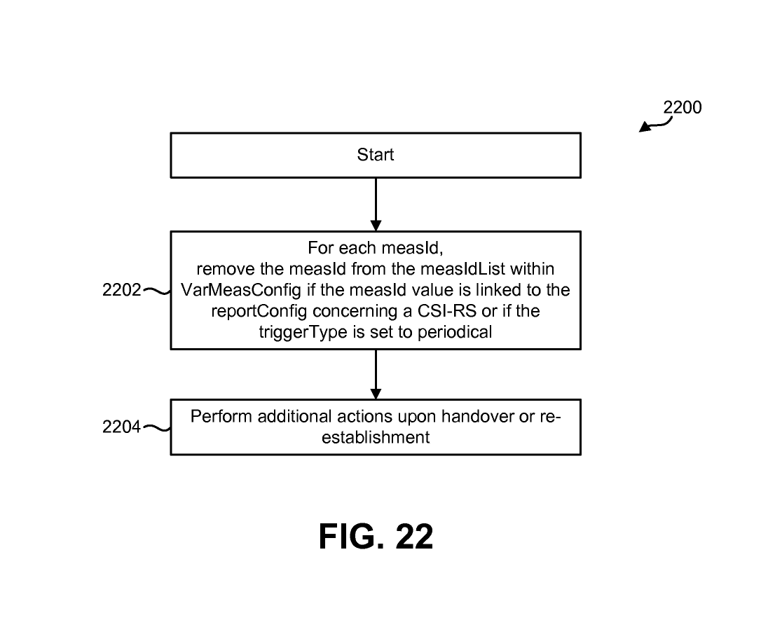

FIG. 22 is a flow diagram of another method 2200 for performing actions upon handover or re-establishment. The method 2200 may correspond to performing 1508 actions upon handover or re-establishment of FIG. 15. The method 2200 may be performed by a user equipment (UE) 104. The eNB 102 may consider/assume that the user equipment (UE) 104 has performed the method 2200.

The method 1600 may begin. For each measId 878, the user equipment (UE) 104 may remove 2202 the measId 878 from the measIdList 865 within VarMeasConfig 864 if the measId 878 value is linked to the reportConfig concerning a CSI-RS or if the trigger type is set to periodical. The user equipment (UE) 104 may then perform 2204 additional actions upon handover or re-establishment. Performing 2204 additional actions upon handover or re-establishment was discussed above in relation to FIG. 17.

As an example, the methods 1500, 1700, 1800, 2100 and 2200 may be used for actions upon handover or re-establishment. The CSI-RS based measurement (i.e., the measId 878) may be removed whenever the user equipment (UE) 104 performed any handover/re-establishment.

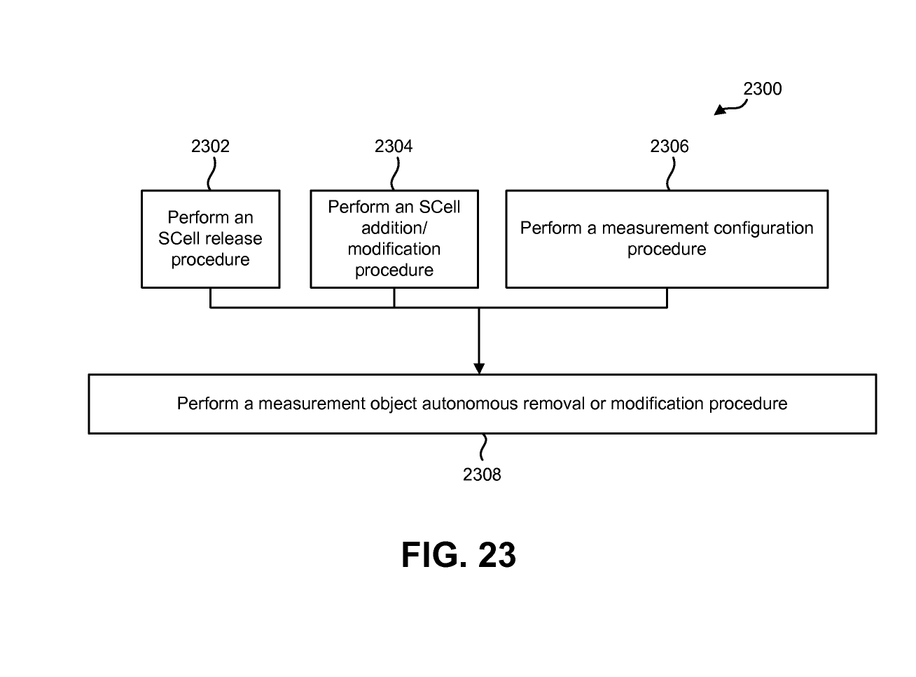

FIG. 23 is a flow diagram of a method 2300 for measurement object autonomous removal or modification related to coordinated multipoint (CoMP) resource management (CRM) measurements. The method 2300 may be performed by a user equipment (UE) 104. The eNB 102 may consider/assume that the user equipment (UE) 104 has performed the method 2300.

The method 2300 may be performed during a radio resource control (RRC) connection reconfiguration procedure or during a radio resource control (RRC) connection re-establishment procedure. In one configuration, the method 2300 may be performed after the user equipment (UE) 104 has performed 2302 an SCell release procedure during a radio resource control (RRC) connection reconfiguration procedure. In another configuration, the method 2300 may be performed after the user equipment (UE) 104 has performed 2302 an SCell release procedure during a radio resource control (RRC) connection re-establishment procedure.

In another configuration, the method 2300 may be performed after the user equipment (UE) 104 has performed 2304 an SCell addition/modification procedure during a radio resource control (RRC) connection reconfiguration procedure. The method 2300 may also be performed after the user equipment (UE) 104 has performed 2304 an SCell addition/modification procedure during a radio resource control (RRC) connection re-establishment procedure. The method 2300 may further be performed after the user equipment (UE) 104 has performed 2306 a measurement configuration procedure during a radio resource control (RRC) connection reconfiguration procedure. The method 2300 may also be performed after the user equipment (UE) 104 has performed 2306 a measurement configuration procedure during a radio resource control (RRC) connection re-establishment procedure.

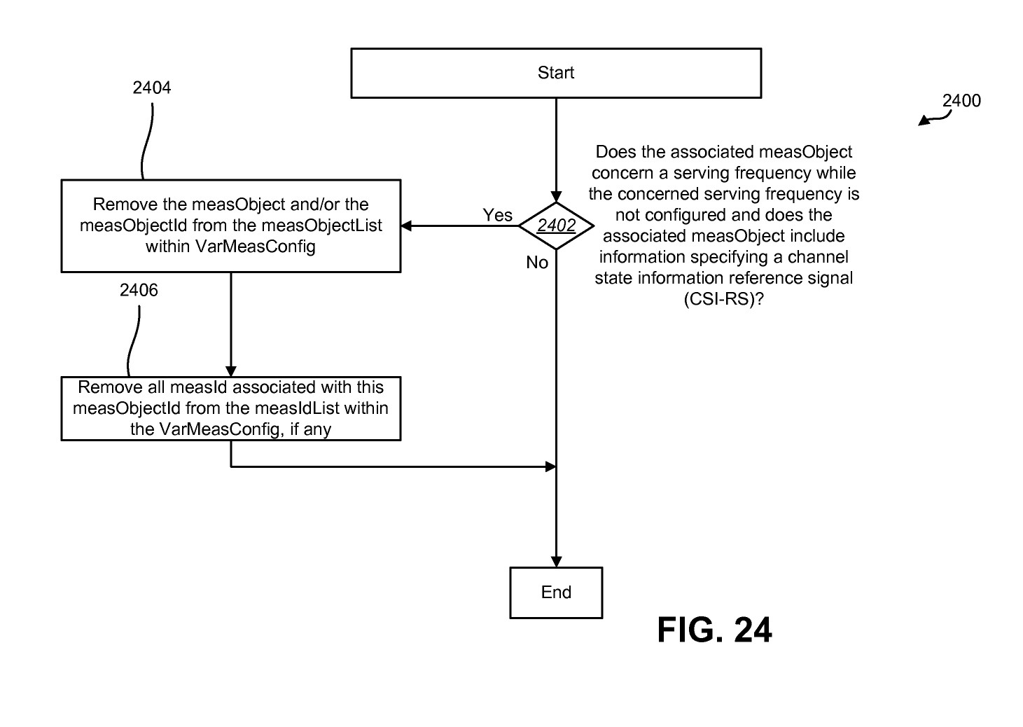

After any of these procedures, the user equipment (UE) 104 may perform 2308 a measurement object autonomous removal or modification procedure. The measurement object autonomous removal or modification procedure may be performed 2308 for each measObjectId 879 within a VarMeasConfig 864. A measurement object autonomous removal or modification procedure is described in more detail below in relation to FIG. 24.

FIG. 24 is a flow diagram of a method 2400 for measurement object autonomous removal or modification. The method 2400 may be performed by a user equipment (UE) 104. The eNB 102 may consider/assume that the user equipment (UE) 104 has performed the method 2400. FIG. 24 illustrates one method 2400 for performing 2308 a measurement object autonomous removal or modification procedure of FIG. 23. The method 2400 may be performed for each measObjectlld 879 within a VarMeasConfig 864.

The user equipment (UE) 104 may determine 2402 whether an associated measObject concerns a serving frequency (or a serving cell) while the concerned serving frequency (or the concerned serving cell) is not configured and the associated measObject includes information related to a channel state information reference signal (CSI-RS) (e.g., information specifying a CSI-RS, CSI-RS resource configurations, CSI-RS indexes and/or CSI-RS resource indexes). If an associated measObject concerns a serving frequency (or a serving cell) while the concerned serving frequency (or the concerned serving cell) is not configured and the associated measObject includes information related to a channel state information reference signal (CSI-RS), the user equipment (UE) 104 may remove 2404 the measObject and/or the measObjectId 879 from the measObjectList 866 within VarMeasConfig 864.

In one configuration, instead of removing 2404 the measObject and/or the measObjectId 879 from the measObjectList 866 within VarMeasConfig 864, the user equipment (UE) 104 may modify the measObject and/or the measObjectId 879 from the measObjectList 866 within VarMeasConfig 864 by removing information related to a channel state information reference signal (CSI-RS) from the measObject.

The user equipment (UE) 104 may then proceed to remove 2406 all measId associated with this measObjectId 879 from the measIdList 865 within the VarMeasConfig, if any. Alternatively of 2406, the user equipment (UE) 104 may then proceed to remove 2406 all measId 878 associated with this measObjectId 879 and associated with ReportConfig concerning a CSI-RS from the measIdList 865 within the VarMeasConfig 864, if any. The method 2400 may then end.

If an associated measObject does not concern a serving frequency (or a serving cell) while the concerned serving frequency (or the concerned serving cell) is not configured or the associated measObject does not include information related to a channel state information reference signal (CSI-RS), the method 2400 may end.

When the serving frequency (or the serving cell) is de-configured to SCell release, channel state information reference signal (CSI-RS) based measurements (i.e., measurement identities (measId) 878) concerning the serving frequency (or the serving cell) may be removed. Namely, the user equipment (UE) 104 may perform measurement object autonomous removal or modification for a channel state information reference signal (CSI-RS) based measurement concerning a CSI-RS in a serving frequency when the serving frequency is released. A channel state information reference signal (CSI-RS) resource may be configured for a serving cell or alternatively for a serving frequency of a serving cell. In performing channel state information reference signal (CSI-RS) based measurements, the measurements may not relate specifically to the serving cell, but rather to the configured channel state information reference signal (CSI-RS) in a serving frequency.

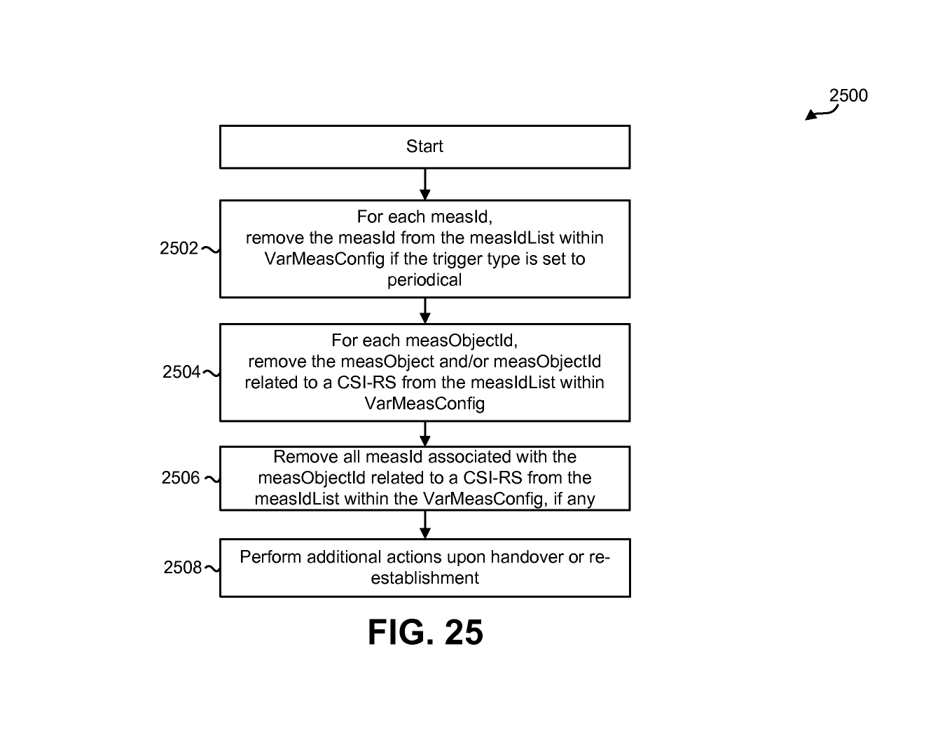

FIG. 25 is a flow diagram of another method 2500 for performing actions upon handover or re-establishment. The method 2500 may correspond to performing 1508 actions upon handover or re-establishment of FIG. 15. The method 2500 may be an alternative of the method 1600 or the method 2200. The method 2500 may be performed by a user equipment (UE) 104. The eNB 102 may consider/assume that the user equipment (UE) 104 has performed the method 2500.

The method 2500 may begin. For each measId 878, the user equipment (UE) 104 may remove 2502 the measId 878 from the measIdList 865 within VarMeasConfig 864 if the trigger type is set to periodical. For each measObjectId 879, the user equipment (UE) 104 may remove 2504 the measObject and/or the measObjectId 879 including or concerning information related to a CSI-RS from the measObjectList 866 within VarMeasConfig 864.

In one configuration, instead of removing 2504 the measObject and/or the measObjectId 879 including or concerning information related to a CSI-RS from the measObjectList 866 within VarMeasConfig 864, the user equipment (UE) 104 may modify the measObject and/or the measObjectId 879 including or concerning information related to a CSI-RS from the measObjectList 866 within VarMeasConfig 864 by removing information related to a channel state information reference signal (CSI-RS) from the measObject.

The user equipment (UE) 104 may then proceed to remove 2506 all measId 878 associated with the measObjectId 879 including or concerning information related to a CSI-RS from the measIdList 865 within the VarMeasConfig, if any. In one configuration, instead of removing 2506 all measId 878 associated with the measObjectId 879 including or concerning information related to a CSI-RS from the measIdList 865 within the VarMeasConfig, the user equipment (UE) 104 may remove 2506 all measId 879 associated with the measObjectId 879 including or concerning information related to a CSI-RS and associated with ReportConfig concerning a CSI-RS from the measIdList 865 within the VarMeasConfig, if any.

The user equipment (UE) 104 may then perform 2508 additional actions upon handover or re-establishment. Performing 2508 additional actions upon handover or re-establishment was discussed above in relation to FIG. 17. In one configuration, the user equipment (UE) 104 may remove 2506 all measId 878 associated with the measObjectId 879 including or concerning information related to a CSI-RS from the measIdList 865 within the VarMeasConfig, if any, prior to removing 2504 the measObject and/or the measObjectId 879 including or concerning information related to a CSI-RS from the measObjectList 866 within VarMeasConfig 864

In the example illustrated in FIG. 25, the CSI-RS based measurement (i.e., the measurement identity (measId) 878 and/or measurement object (measObject)) may be removed or modified whenever the user equipment (UE) 104 performed any handover/re-establishment.

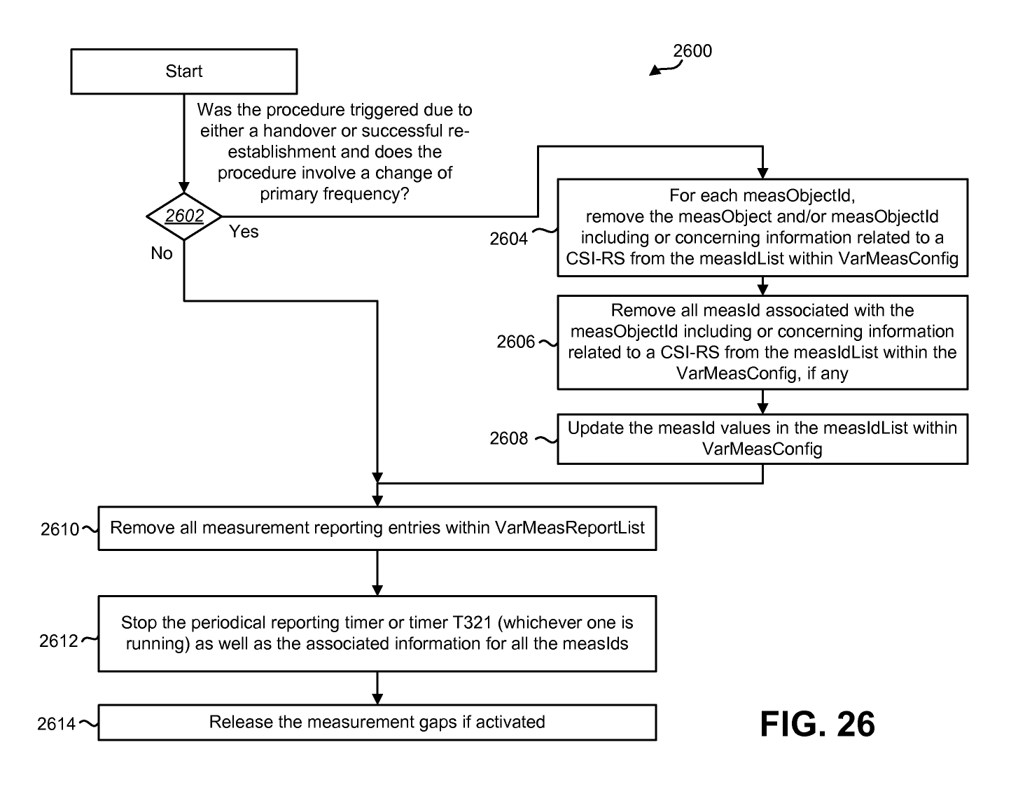

FIG. 26 is a flow diagram of yet another method 2600 for performing actions upon handover or re-establishment. The method 2600 may correspond to performing 1606 additional actions upon handover or re-establishment of FIG. 16. The method 2600 may be an alternative of the method 1700. The method 2600 may be performed by a user equipment (UE) 104. The eNB 102 may consider/assume that the user equipment (UE) 104 has performed the method 2600.

The method 2600 may begin. The user equipment (UE) 104 may determine 2602 whether the procedure (i.e., the method 2600) was triggered due to either a handover or a successful re-establishment and the procedure involves a change of primary frequency. If the procedure was triggered due to either a handover or a successful re-establishment and the procedure involves a change of primary frequency, the user equipment (UE) 104, for each measObjectId 879, may remove 2604 the measObject and/or the measObjectId 879 including or concerning information related to a CSI-RS from the measObjectList 866 within VarMeasConfig 864. Instead of removing 2604 the measObject and/or the measObjectId 879 including or concerning information related to a CSI-RS from the measObjectList 866 within VarMeasConfig 864, the user equipment (UE) 104 may modify the measObject and/or the measObjectId including or concerning information related to a CSI-RS from the measObjectList 866 within VarMeasConfig 864 by removing information related to a channel state information reference signal (CSI-RS) from the measObject.

The user equipment (UE) 104 may then proceed to remove 2606 all measId 878 associated with the measObjectId 879 including or concerning information related to a CSI-RS from the measIdList 865 within the VarMeasConfig, if any. In one configuration, instead of removing 2606 all measId 878 associated with the measObjectId 879 including or concerning information related to a CSI-RS from the measIdList 865 within the VarMeasConfig 864, the user equipment (UE) 104 may remove all measId 878 associated with this measObjectId 879 including or concerning information related to a CSI-RS and associated with ReportConfig concerning a CSI-RS from the measIdList 865 within the VarMeasConfig 864, if any.

The user equipment (UE) 104 may then update 2608 the measId 878 values in the measIdList 865 within VarMeasConfig 864. Updating 2608 the measId 878 values in the measIdList 865 within VarMeasConfig 864 is discussed in additional detail above in relation to FIG. 18. The user equipment (UE) 104 may remove 2610 all measurement reporting entries within VarMeasReportList 968.

If the procedure was not triggered due to either a handover or a successful re-establishment procedure and/or the procedure does not involve a change of primary frequency, the user equipment (UE) 104 may remove 2610 all measurement reporting entries within VarMeasReportList 968.

Once the user equipment (UE) has removed 2610 all measurement reporting entries within VarMeasReportList 968, the user equipment (UE) 104 may stop 2612 the periodical reporting timer or timer T321 (whichever one is running) as well as the associated information (e.g., timeToTrigger) for all the measIds 878. The user equipment (UE) 104 may also release 2614 the measurement gaps, if activated.

In the example illustrated by FIG. 26, when the user equipment (UE) 104 performs inter-frequency handover or inter-frequency re-establishment (i.e., change of primary frequency), a channel state information reference signal (CSI-RS) measurement (i.e., measurement identity (measId) 878 and/or measurement object (measObject)) related to the source primary frequency may be removed or modified. When the user equipment (UE) 104 performs intra-frequency handover or intra-frequency re-establishment (i.e., no change of primary frequency), a channel state information reference signal (CSI-RS) based measurement related to the source primary frequency may be kept. Using channel state information reference signal (CSI-RS) measurement while performing inter-frequency or intra-frequency handover or re-establishment may improve the efficiency of updating measurement identities and/or measurement objects while performing these procedures.

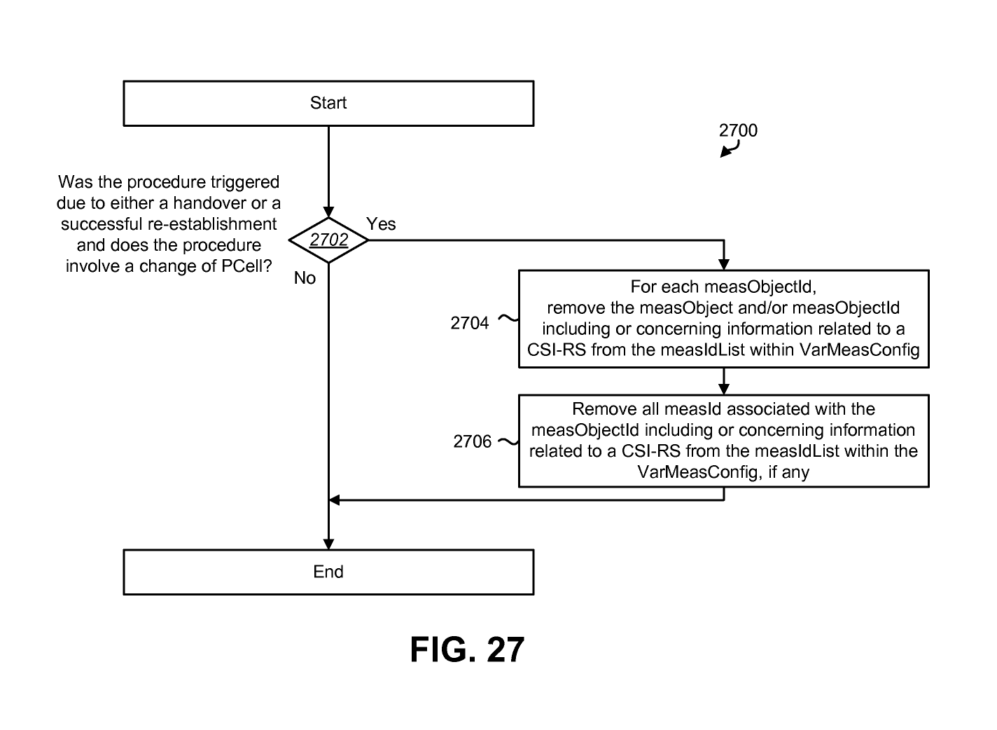

FIG. 27 is a flow diagram of yet another method 2700 for performing actions upon handover or re-establishment. The method 2700 may correspond to performing 1606 additional actions upon handover or re-establishment of FIG. 16. The method 2700 may be an alternative of the method 2000. The method 2700 may be performed by a user equipment (UE) 104. The eNB 102 may consider/assume that the user equipment (UE) 104 has performed the method 2700.

The method 2700 may start. The user equipment (UE) 104 may determine 2702 whether the procedure (i.e., the method 2700) was triggered due to either a handover or a successful re-establishment and whether the procedure involves a change of PCell 107a. If the procedure was triggered due to either a handover or a successful re-establishment and the procedure involves a change of PCell 107a, the user equipment (UE) 104 may, for each measObjectId 879, remove 2704 the measObject and/or the measObjectId 879 including or concerning information related to a CSI-RS from the measObjectList 866 within VarMeasConfig 864. In one configuration, instead of removing 2704 the measObject and/or the measObjectId 879 including or concerning information related to a CSI-RS from the measObjectList 866 within VarMeasConfig 864, the user equipment (UE) 104 may modify the measObject and/or the measObjectId 879 including or concerning information related to a CSI-RS from the measObjectList 866 within VarMeasConfig 864 by removing information related to a channel state information reference signal (CSI-RS) from the measObject.

The user equipment (UE) 104 may then remove 2706 all measId 878 associated with the measObjectId 879 including or concerning information related to a CSI-RS from the measIdList 865 within the VarMeasConfig 864, if any. In one configuration, instead of removing 2706 all measId 878 associated with the measObjectId 879 including or concerning information related to a CSI-RS from the measIdList 865 within the VarMeasConfig 864, the user equipment (UE) 104 may remove all measId 878 associated with this measObjectId 879 including or concerning information related to a CSI-RS and associated with ReportConfig concerning a CSI-RS from the measIdList 865 within the VarMeasConfig 864, if any.

The method 2700 may then end. If the procedure wasn't triggered due to either a handover or a successful re-establishment or the procedure doesn't involve a change of PCell 107a, the method 2700 may end. Once the method 2700 has ended, the method 1700 of FIG. 17 may be performed. Thus, the method 2700 is an additional procedure that may be performed before the method 1700 of FIG. 17.

In the example illustrated by FIG. 27, when the user equipment (UE) 104 performs inter-cell handover or inter-cell re-establishment (e.g., a change of PCell 107a), the channel state information reference signal (CSI-RS) based measurement (i.e., measurement identity (measId) 878 and/or measurement object (measObject)) related to the source PCell 107a may be removed or modified. Inter-cell handover may be any normal handover operation except for intra-cell handover (e.g., handover used for security updates for a cell). The inter-cell re-establishment operation may include scenarios where a user equipment (UE) 104 returns to another cell than the source PCell 107a in cases of inter-cell handover failure or mobility from E-UTRAN failure.

The intra-cell re-establishment may include cases that the user equipment (UE) 104 returns to the PCell 107a in which the trigger for re-establishment occurred due to detecting radio link failure, integrity check failure from lower layers or a radio resource control (RRC) connection reconfiguration procedure failure. In some configurations, when a user equipment (UE) 104 performs intra-cell handover or intra-cell reconfiguration with no change of the PCell 107a, channel state information reference signal (CSI-RS) based measurements related to the source PCell 107a may be kept. Keeping the channel state information reference signal (CSI-RS) based measurements during intra-cell handover or intra-cell reconfiguration may result in more efficient updates of measurement identities and/or measurement objects.

One benefit of the above methods is that the eNB 102 and the user equipment (UE) 104 can operate efficiently and sustainably in scenarios where CSI-RS based radio resource management (RRM) measurement is used in addition to CRS based radio resource management (RRM) measurement. The eNB 102 can measure more detail of the channels associated with the user equipment (UE) 104. Also CSI-RS based radio resource management (RRM) measurement can be used even when multiple serving cells are configured. CSI-RSs of a coordinated multipoint (CoMP) resource management (CRM) set may be a subset of all CSI-RSs configured. Therefore, a CSI-RS above can be replaced with a CSI-RS of a coordinated multipoint (CoMP) resource management (CRM) set because these methods may be applicable only to a coordinated multipoint (CoMP) resource management (CRM) set.

The cell-specific reference signal (CRS) may also be referred to as the common reference signal (RS). The radio resource management (RRM) measurement report 122 may also be referred to as the measurement report or the measurement report in the radio resource control (RRC) layer 353. The CSI-RSRP may also be referred to as the CSI-RS RSRP. The CSI-RSRQ may also be referred to as the CSI-RS RSRQ. Further, the various names used for the described parameters and signal elements (e.g., CSI-RS, CRS, csi-RS-Config-r11, etc.) are not intended to be limiting in any respect, as these parameters and signal elements may be identified by any suitable names.

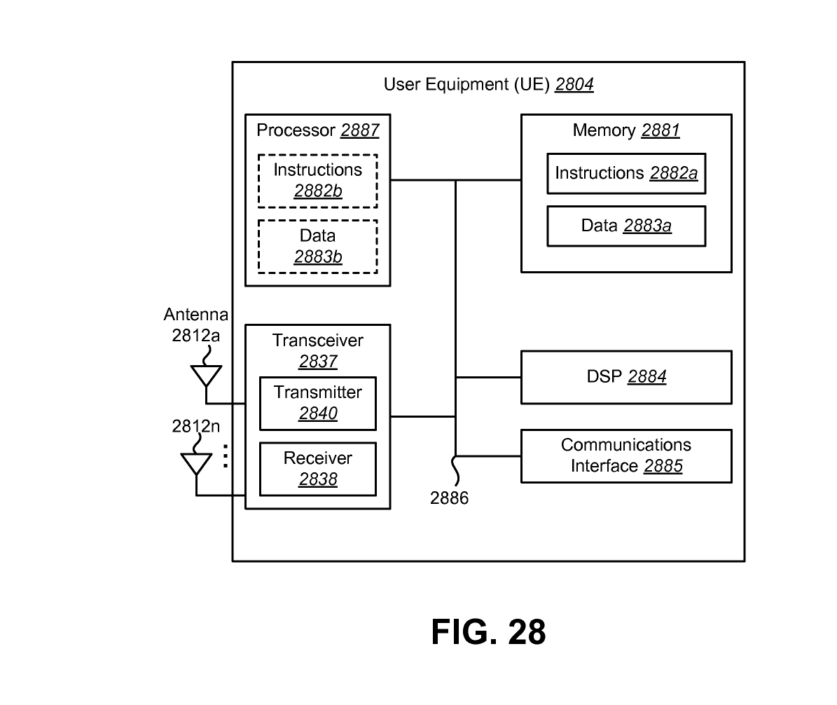

FIG. 28 illustrates various components that may be utilized in a user equipment (UE) 2804. The user equipment (UE) 2804 may be utilized as the user equipment (UE) 104 illustrated previously. The user equipment (UE) 2804 includes a processor 2887 that controls operation of the user equipment (UE) 2804. The processor 2887 may also be referred to as a CPU. Memory 2881, which may include both read-only memory (ROM), random access memory (RAM) or any type of device that may store information, provides instructions 2882a and data 2883a to the processor 2887. A portion of the memory 2881 may also include non-volatile random access memory (NVRAM). Instructions 2882b and data 2883b may also reside in the processor 2887. Instructions 2882b and/or data 2883b loaded into the processor 2887 may also include instructions 2882a and/or data 2883a from memory 2881 that were loaded for execution or processing by the processor 2887. The instructions 2882b may be executed by the processor 2887 to implement the systems and methods disclosed herein.

The user equipment (UE) 2804 may also include a housing that contains a transmitter 2840 and a receiver 2838 to allow transmission and reception of data. The transmitter 2840 and receiver 2838 may be combined into a transceiver 2837. One or more antennas 2812a-n are attached to the housing and electrically coupled to the transceiver 2837.

The various components of the user equipment (UE) 2804 are coupled together by a bus system 2886, which may include a power bus, a control signal bus, and a status signal bus, in addition to a data bus. However, for the sake of clarity, the various buses are illustrated in FIG. 28 as the bus system 2886. The user equipment (UE) 2804 may also include a digital signal processor (DSP) 2884 for use in processing signals. The user equipment (UE) 2804 may also include a communications interface 2885 that provides user access to the functions of the user equipment (UE) 2804. The user equipment (UE) 2804 illustrated in FIG. 28 is a functional block diagram rather than a listing of specific components.

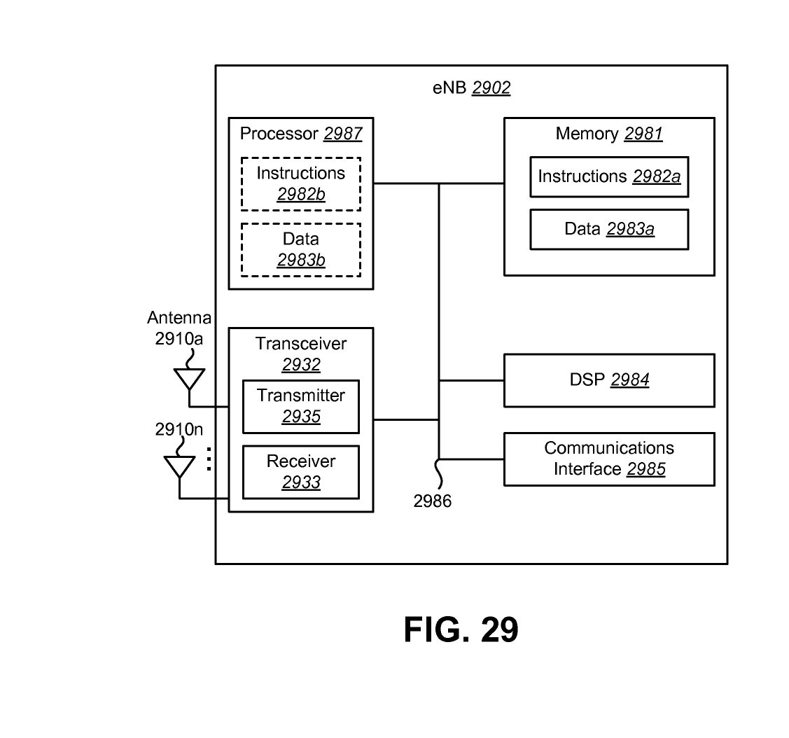

FIG. 29 illustrates various components that may be utilized in an eNB 2902. The eNB 2902 may be utilized as the eNB 102 illustrated previously. The eNB 2902 may include components that are similar to the components discussed above in relation to the user equipment (UE) 2804, including a processor 2987, memory 2981 that provides instructions 2982a and data 2983a to the processor 2987, instructions 2982b and data 2983b that may reside in or be loaded into the processor 2987, a housing that contains a transmitter 2935 and a receiver 2933 (which may be combined into a transceiver 2932), one or more antennas 2910a-n electrically coupled to the transceiver 2932, a bus system 2986, a DSP 2984 for use in processing signals, a communications interface 2985 and so forth.

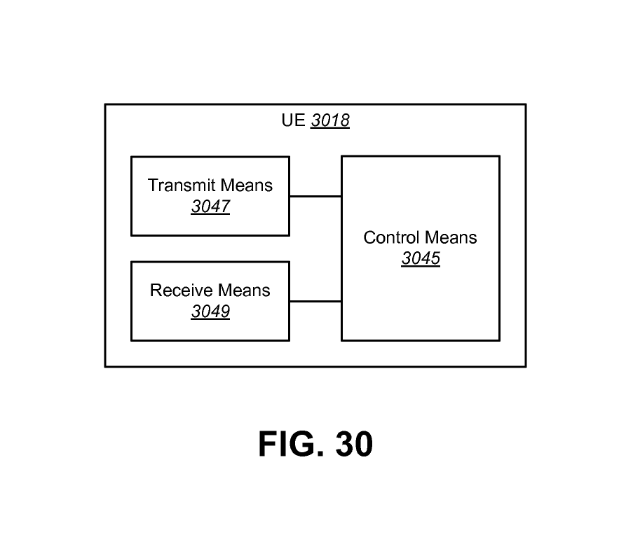

FIG. 30 is a block diagram illustrating one configuration of a user equipment (UE) 3018 in which systems and methods for coordinated multipoint (CoMP) resource management (CRM) measurement may be implemented. The user equipment (UE) 3018 includes transmit means 3047, receive means 3049 and control means 3045. The transmit means 3047, receive means 3049 and control means 3045 may be configured to perform one or more of the functions described in connection with FIG. 11 and FIG. 30 above. FIG. 30 above illustrates one example of a concrete apparatus structure of FIG. 30. Other various structures may be implemented to realize one or more of the functions of FIG. 30. For example, a DSP may be realized by software.

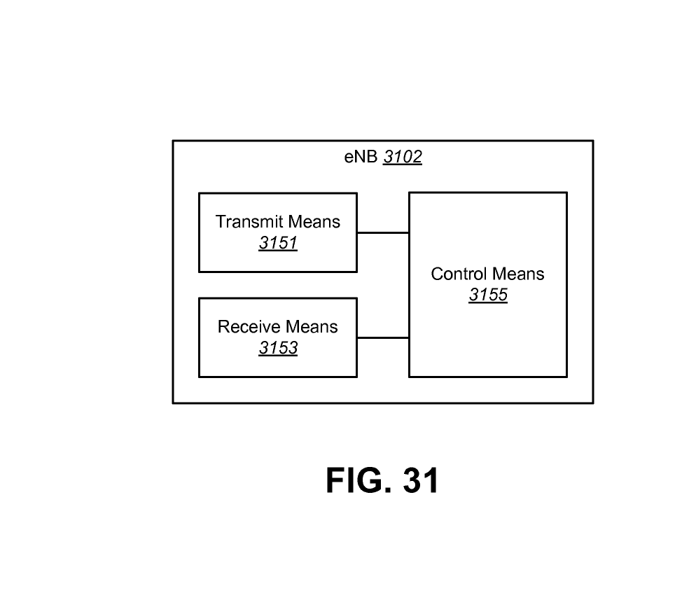

FIG. 31 is a block diagram illustrating one configuration of an eNB 3102 in which systems and methods for coordinated multipoint (CoMP) radio resource management (RRM) measurement may be implemented. The eNB 3102 includes transmit means 3151, receive means 3153 and control means 3155. The transmit means 3151, receive means 3153 and control means 3155 may be configured to perform one or more of the functions described above. FIG. 31 above illustrates one example of a concrete apparatus structure of FIG. 31. Other various structures may be implemented to realize one or more of the functions of FIG. 31. For example, a DSP may be realized by software.

Unless otherwise noted, the use of ‘/’ above represents the phrase “and/or.”

The functions described herein may be implemented in hardware, software, firmware or any combination thereof. If implemented in software, the functions may be stored as one or more instructions on a computer-readable medium. The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory may be integral to a processor and still be said to be in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

Software or instructions may also be transmitted over a transmission medium. For example, if the software is transmitted from a website, server, or other remote source using a coaxial cable, fiber optic cable, twisted pair, digital subscriber line (DSL) or wireless technologies such as infrared, radio, and microwave, then the coaxial cable, fiber optic cable, twisted pair, DSL, or wireless technologies such as infrared, radio and microwave are included in the definition of transmission medium.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for performing a measurement object procedure, comprising:
performing autonomous modification of measurement objects related to a channel state information reference signal (CSI-RS).

2. The method of claim 1, wherein performing autonomous modification of measurement objects comprises:
determining whether a measurement object comprises information related to a CSI-RS; and
modifying the measurement object from a measObjectList within a VarMeasConfig if the measurement object comprises information related to a CSI-RS.

3. The method of claim 2, wherein the method is performed for each measObjectId in the measObjectList within the VarMeasConfig.

4. The method of claim 1, wherein the method is performed by a user equipment (UE).

5. The method of claim 1, further comprising performing an SCell release procedure.

6. The method of claim 1, further comprising performing an SCell addition/modification procedure.

7. The method of claim 1, further comprising performing a measurement configuration procedure.

8. The method of claim 1, wherein the autonomous modification of measurement objects related to a serving frequency is performed if the concerned serving frequency is not configured.

9. The method of claim 1, wherein the autonomous modification of measurement objects related to a serving cell is performed if the concerned serving cell is not configured.

10. A method for performing a measurement procedure, comprising:
performing a modification of measurement objects related to a channel state information reference signal (CSI-RS) due to a handover or a successful re-establishment.

11. The method of claim 10, wherein the modification is performed due to a handover or a successful re-establishment which involves a change of PCell.

12. The method of claim 10, wherein the modification is performed due to a handover or a successful re-establishment which involves a change of primary frequency.

13. A user equipment (UE) configured for performing a measurement object procedure, comprising:
a processor;
memory in electronic communication with the processor, wherein instructions stored in the memory are executable to:
perform autonomous modification of measurement objects related to a channel state information reference signal (CSI-RS).

14. The UE of claim 13, wherein the instructions executable to perform autonomous modification of measurement objects comprise instructions executable to:
determine whether a measurement object comprises information related to a CSI-RS; and
modify the measurement object from a measObjectList within a VarMeasConfig if the measurement object comprises information related to a CSI-RS.

15. The UE of claim 14, wherein the instructions executable to perform autonomous modification of measurement objects are performed for each measObjectId in the measObjectList within the VarMeasConfig.

16. The UE of claim 13, wherein the instructions are further executable to perform an SCell release procedure.

17. The UE of claim 13, wherein the instructions are further executable to perform an SCell addition/modification procedure.

18. The UE of claim 13, wherein the instructions are further executable to perform a measurement configuration procedure.

19. The UE of claim 13, wherein the autonomous modification of measurement objects related to a serving frequency is performed if the concerned serving frequency is not configured.

20. The UE of claim 13, wherein the autonomous modification of measurement objects related to a serving cell is performed if the concerned serving cell is not configured.

21. A user equipment (UE) configured for performing a measurement procedure, comprising:
a processor;
memory in electronic communication with the processor, wherein instructions stored in the memory are executable to:
perform a modification of measurement objects related to a channel state information reference signal (CSI-RS) due to a handover or a successful re-establishment.

22. The UE of claim 21, wherein the modification is performed due to a handover or a successful re-establishment which involves a change of PCell.

23. The UE of claim 21, wherein the modification is performed due to a handover or a successful re-establishment which involves a change of primary frequency.
